(19) United States
(12) Patent Application Publication
(10) Pub. No.: US 2025/0279900 A1
(43) Pub. Date: Sep. 4, 2025

(54) Method for controlling an apparatus, method for transmitting operating data of an apparatus, communication apparatus for use in such methods, computer program, computer-readable medium and data carrier signal

(71) Applicant: UMH Systems GmbH, Köln (DE)

(72) Inventors: Jeremy Theocharis, Köln (DE); Ferdinand Linnenberg, Köln (DE)

(21) Appl. No.: 18/858,491

(22) PCT Filed: Apr. 21, 2023
(86) PCT No.: PCT/EP2023/060459

§ 371 Date: Oct. 21, 2024

(30) Foreign Application Priority Data
Apr. 21, 2022 (DE) 10 2022 109 649.1

(51) Int. Cl. H04L 9/32; H04L 9/08

(52) U.S. Cl. CPC H04L 9/3268; H04L 9/0825; H04L 9/3247

(57) ABSTRACT

The invention relates to a method for controlling an apparatus (10), wherein
a communication apparatus (12) is connected to the apparatus (10);
in a step S1, the communication apparatus (12) receives a plaintext and a signature from a sender apparatus (14);
in a step S2, the communication apparatus (12) verifies a first identifier (ID1), which is assigned to the sender apparatus (14), and a first encryption key (CS1) using a valid first certificate (Z1) and aborts the method if the result of this verification is negative;
in a step S3, the communication apparatus (12) verifies the received signature and the received plaintext using the first encryption key (CS1) and aborts the method if the result of this verification is negative;
in a step S4, the communication apparatus (12) checks whether a control instruction for the apparatus (10) is contained in the plaintext, and aborts the method if the result of this check is negative;
in a step S5, the communication apparatus (12) checks whether an authorization for the control instruction is assigned to the first encryption key (CS1) and/or the first identifier (ID1), and aborts the method if the result of this check is negative;
in a step S6, the communication apparatus (12) generates a control command for the apparatus (10) using the control instruction contained in the recovered plaintext; and
in a step S7, the communication apparatus (12) sends the control command to the apparatus (10), whereby the apparatus (10) is controlled.

This enables a secure information technological and communication technological networking and data transmission between the sender apparatus (14) and the apparatus (12).

The invention relates to a method for controlling an apparatus, a method for transmitting operating data of an apparatus, a communication apparatus for use in such methods, a computer program, a computer-readable medium and a data carrier signal.

The Internet of Things, or “IoT” for short, is becoming increasingly important, especially in industrial applications, and is in this context also referred to as the Industrial Internet of Things, or “IIoT” short. The technical implementation of the IoT or IIoT usually takes place with the help of so-called IoT or IIoT platforms, which are intended to enable the information and communication technology networking of participants realized by hardware and/or software. For example, a machine operator or other operator can remotely control and/or monitor the operation of a machine, such as a lathe, CNC machine, printing machine or filling machine, via the internet using a smartphone or laptop. Other examples of IIoT participants, i.e. facilities that can be networked via IIoT platforms, include flexible manufacturing cells, flexible manufacturing systems, flexible or rigid transfer lines, power plants, hydroelectric plants, wind turbines, solar plants, photovoltaic plants, wastewater treatment plants, blast furnaces, steel mills, foundries, rolling mills, oil refineries and aluminum smelters, as well as cloud-hosted applications such as databases and/or enterprise resource planning systems, or “ERP systems” short.

The task of the invention is to make the information and communication technology networking and data transmission required for IoT and, in particular, IIoT platforms more secure and/or simpler.

Against this background, the invention proposes the subject matter of the independent claims. Advantageous embodiments of the invention are described in the dependent claims.

The invention proposes according to a first aspect, a method for controlling an apparatus, wherein
a communication apparatus is or is being connected to the apparatus;
in a step S1 the communication apparatus receives a plaintext and a signature from a sender apparatus;
in a step S2 the communication apparatus verifies a first identifier, which is associated with the sender apparatus, and a first encryption key using a valid first certificate and aborts the method if the result of this verification is negative;
in a step S3 the communication apparatus verifies the received signature and the received plaintext using the first encryption key and aborts the method if the result of this verification is negative;
in a step S4 the communication apparatus checks whether a control instruction for the apparatus is contained in the plaintext and aborts the method if the result of this check is negative;
in a step S5 the communication apparatus checks whether an authorization for the control instruction is assigned to the first encryption key and/or the first identifier, and aborts the method if the result of this check is negative;
in a step S6 the communication apparatus generates a control command for the apparatus using the control instruction included in the recovered plaintext; and
in a step S7 the communication apparatus sends the control command to the apparatus, whereby the apparatus is controlled.

The method proposed in accordance with this aspect, which is also referred to as a control method in the context of the present invention, enables secure information technological and communication technological networking and data transmission between the sender apparatus and the apparatus. Furthermore, the use of a virtual private network, or “VPN” short, can be dispensed with for this data transmission without jeopardizing the security of the data transmission. A VPN involves a high technical effort in terms of the hardware and software required.

The apparatus and the sender apparatus can be configured in any way as required and each comprise, for example, at least one measuring apparatus, at least one machine, at least one computer, at least one production system, at least one technical system and/or at least one of the IIoT participants mentioned above.

The described method according to any of the aspects may for example be performed by a device. A device, in particular a computer, which for example performs or can perform a method or one or more method steps of one of the described methods or has means for performing them, may comprise at least one processor and at least one memory in which instructions are stored which, when executed by the at least one processor, cause the device to perform at least the specified steps. The device may comprise, for example, the apparatus and/or the communication apparatus. For example, the apparatus and the communication apparatus may be physically or virtually separate units of the device.

In the context of the present invention, the term “signature” refers to a data set, a value, a number or a character string, whereas the term “signature file” refers to a file that contains at least one signature and optionally has a metadata area that contains further data, in particular metadata. Such signatures are described, for example, in the Wikipedia article “Digital signature”.

In the context of the present invention, the term “key” refers to a data set, value, number or character string, whereas the term “key file” refers to a file that contains at least one key and optionally has a metadata area that contains further data, in particular metadata. This applies analogously to the terms “encryption key” and “encryption key file” as well as “decryption key” and “decryption key file”. If, for example, an encryption key and a decryption key are formed according to the RSA cryptosystem, then each of these keys is a data set comprising a pair of numbers. Each key, encryption key and decryption key as well as each key file, encryption key file and decryption key file can be formed in any way as required, for example in accordance with the standards for asymmetric cryptography, or “PKCS” short.

In the context of the present invention, the term “certificate” means a digital certificate which is, for example, configured in accordance with ITU-T or IETF standards.

The receiving in step S1 can take place in any way as required, for example by the sender apparatus sending a file containing the plaintext and a signature file containing the signature, or only a signature file containing the signature and the plaintext as metadata, to the communication apparatus. This transmission takes place via a VPN, for example.

The verification in step S3 can be carried out in any way as required, for example by using the first encryption key to check whether the received signature matches with the received plaintext.

In an example embodiment of the invention, the sender apparatus
has signed or signs a plain text which contains a control instruction for the apparatus, using a first decryption key which corresponds to the first encryption key, whereby the signature has been or is generated, and
has sent or sends the plain text and the signature to the communication apparatus.

The invention proposes according to a second aspect, a method for controlling an apparatus, wherein
a communication apparatus is or is being connected to the apparatus;
in a step S8 the communication apparatus receives a ciphertext and a signature from a sender apparatus, wherein the ciphertext represents an encrypted plaintext;
in a step S9 the communication apparatus verifies a first identifier which is associated with the sender apparatus and a first encryption key using a valid first certificate and aborts the method if the result of this verification is negative;
in a step S10 the communication apparatus transmits the received ciphertext using a second decryption key which is associated with the communication apparatus, whereby the plaintext is recovered;
in a step S11 the communication apparatus verifies the received signature and the received ciphertext or the received signature and the recovered plaintext using the first encryption key and aborts the method if the result of this verification is negative;
in a step S12 the communication apparatus checks whether a control instruction for the apparatus is contained in the plaintext and aborts the method if the result of this check is negative;
in a step S13 the communication apparatus checks whether an authorization for the control instruction is assigned to the first encryption key and/or the first identifier, and aborts the method if the result of this check is negative;
in a step S14 the communication apparatus generates a control command for the apparatus using the control instruction included in the recovered plaintext; and
in a step S15 the communication apparatus sends the control command to the apparatus, whereby the apparatus is controlled.

The method proposed in accordance with this aspect, which is also referred to as a control method in the context of the present invention, enables secure information technological and communication technological networking and data transmission between the sender apparatus and the apparatus. Furthermore, the use of a VPN for this data transmission can be dispensed with without jeopardizing the security of the data transmission.

The receiving in step S8 can be carried out in any way as required, for example by the sender apparatus sending a file containing the ciphertext and a signature file containing the signature, or only a signature file containing the signature and the ciphertext as metadata, to the communication apparatus. This transmission takes place via a VPN, for example.

The verification in steps S2 and S9 can be performed in any way as required, for example by using the first certificate to check whether the first encryption key matches with the first identifier and/or by using at least one additional valid certificate.

The verification in step S11 can be carried out in any way as required, for example by using the first encryption key to check whether the received signature matches with the received ciphertext or with the recovered plaintext.

The generation in steps S6 and S14 can be carried out in any way as required, for example using a lookup table and/or a database.

In an example embodiment of the invention, the sender apparatus has encrypted or encrypts a plain text containing a control instruction for the apparatus, using a second encryption key that is identical to the second encryption key corresponding to the second decryption key, whereby the ciphertext has been generated or is generated, has signed or signs the plaintext or ciphertext using a first decryption key corresponding to the first encryption key, whereby the signature has been generated or is generated, and has sent or is sends the ciphertext and the signature to the communication apparatus.

In an exemplary embodiment of the invention,
the first encryption key is or is being stored in the communication apparatus; and/or
the first encryption key is contained in the plaintext and/or in a signature file containing the signature, and the communication apparatus extracts the first encryption key from the plaintext and/or from the signature file; and/or
the communication apparatus has received or receives the first encryption key, in particular by downloading it from a key server.

For example, the first encryption key is contained in a metadata area of the signature file, and then the communication apparatus extracts the first encryption key from the metadata area.

In an example embodiment of the invention, the checking according to step S5 or S13 is carried out by the communication apparatus checking whether the authorization is contained in the first encryption key, in particular in a metadata area of the first encryption key, and/or is assigned in a configuration file to the first encryption key and/or the first encryption key.

In an example embodiment of the invention, in a step S16 the communication apparatus checks whether the configuration file has been created using a valid second certificate and aborts the method if the result of this check is negative.

The checking in step S16 can be performed in any way as required, for example using at least one additional valid certificate.

In an example embodiment of the invention, the sending according to step S7 or S15 comprises that the communication apparatus
encrypts the control command using a third encryption key associated with the apparatus, and
sends the encrypted control command to the apparatus.

This increases the security of data transmission between the sender apparatus and the apparatus.

In an example embodiment of the invention, the apparatus decrypts the received encrypted control command using a third decryption key which corresponds to the third encryption key, whereby the control command is recovered.

In an exemplary embodiment of the invention, the transmitting according to step S7 or S15 comprises that the communication apparatus signs the control command using the second decryption key or a fourth decryption key associated with the communication apparatus, thereby generating a signature, and sends the control command and the signature to the apparatus.

This increases the security of data transmission between the sender apparatus and the apparatus.

The fourth decryption key can be configured in any way as required, for example different from the second decryption key or same as the second decryption key.

In an example embodiment of the invention, the apparatus verifies the received control command and the received signature using the second encryption key or a fourth encryption key that corresponds to the fourth decryption key, and aborts the method if the result of this verification is negative.

This verification can be carried out in any way required, for example by using the second or fourth encryption key to check whether the received signature matches with the received control command.

The fourth encryption key can be formed in any way required, for example different to the second encryption key or same as the second encryption key.

In an example embodiment of the invention, the transmitting according to step S7 or S15 comprises that the communication apparatus
encrypts the control command using a third encryption key assigned to the apparatus, signs the control command or the encrypted control command using the second decryption key or a fourth decryption key associated with the communication apparatus, whereby a signature is generated, and
sends the encrypted control command and the signature to the apparatus.

This increases the security of data transmission between the sender apparatus and the apparatus.

In an exemplary embodiment of the invention, the apparatus
decrypts the received encrypted control command using a third decryption key corresponding to the third encryption key, whereby the control command is recovered, and
verifies the received encrypted control command and the received signature or the recovered control command and the received signature using the second encryption key or a fourth encryption key that corresponds to the fourth decryption key and aborts the method if the result of this verification is negative.

This verification can be carried out in any way required, for example by using the second or fourth encryption key to check whether the received signature matches with the received encrypted control command or with the recovered control command.

In an exemplary embodiment of the invention,
in a step S17 the communication apparatus receives or reads from a storage medium a firmware for the communication apparatus; and
in a step S18 the communication apparatus
   checks whether the received firmware was signed using a valid third certificate and aborts the method if the result of this check is negative, and
   installs the firmware.

This enables a secure over-the-air update.

For example, the firmware may be contained in an email, message or file sent to the communication apparatus. The storage medium can be formed in any way as required and can include, for example, cloud storage, USB mass storage, a CD, DVD or BD.

The checking in step S18 may be performed in any manner as required, for example using at least one additional valid certificate.

In an example embodiment of the invention,
the communication apparatus comprises at least one computer; and
at least one of the steps S1 to S18 is carried out with the aid of the computer and/or the first encryption key, the third encryption key, the first identifier and/or the configuration file is stored in the computer.

In an exemplary embodiment of the invention,
the communication apparatus comprises at least one security module; and
at least one of the steps S1 to S18 is carried out with the aid of the security module and/or the first certificate, the second certificate, the third certificate, the second decryption key and/or the fourth decryption key is stored in the security module.

In an example embodiment of the invention,
the communication apparatus comprises
   at least one computer, and
   at least one security module connected to the computer;
data is transferred from the computer to the security module and from the security module to the computer; and
this transmission of data is protected by a transmission protection realized by software and/or hardware which prevents the transmitted data from being read and/or modified and/or ensures that only the computer can control this transmission of data and/or that this transmission of data can only take place with the aid of a password which is stored exclusively in the computer.

In an example embodiment of the invention,
the security module has a write protection realized by software and/or hardware, which prevents an alteration of the first certificate stored in the security module, the second certificate stored in the security module, the second decryption key stored in the security module and/or the fourth decryption key stored in the security module; and/or
the security module has a read protection realized by software and/or hardware, which prevents a read of the second decryption key stored in the security module and/or the fourth decryption key stored in the security module.

In an example embodiment of the invention, before step S1 or S8 in a step S19 an encrypted data connection is established between the sender apparatus and the communication apparatus in accordance with an encryption protocol.

The encryption protocol can be configured in any way required, for example according to TLS, WPA3, IPsec or the signal protocol.

In an example embodiment of the invention,
the apparatus comprises a communication interface which is or is being connected to the communication apparatus or to a first communication interface of the communication apparatus; and/or
the communication apparatus comprises a first communication interface which is or is being connected to the apparatus or a communication interface of the apparatus, and/or comprises a second communication interface which is or is being connected to the sender apparatus or a communication interface of the sender apparatus; and/or
the sender apparatus comprises a communication interface which is or becomes connected to the communication apparatus or to a second communication interface of the communication apparatus.

Each communication interface can be configured as required in any way, for example as a radio interface, infrared interface, USB interface, Ethernet interface or as a wired or fiber optic interface.

In an example embodiment of the invention, the sender apparatus has generated or generates the plaintext.

In an example embodiment of the invention, the control instruction and/or the control command relates to the sending of operating data of the apparatus to the or to a sender apparatus or to the or to a receiver apparatus.

The operating data of the apparatus can, for example, relate to a sub-unit of the apparatus, such as a measuring device, a machine, a computer, a production system, a technical system and/or one of the IIoT participants mentioned above.

In an example embodiment of the invention,
the control instruction and/or the control command relates to sending operating data of the apparatus to the or to a sender apparatus or to the or a receiver apparatus; and
after step S7 or S15, a method such as one of the transmission methods proposed according to the seventh or eighth aspect is performed.

The invention proposes according to a third aspect, a communication apparatus, in particular for use in a method which is formed like one of the control methods proposed according to the first aspect, or for at least partial execution of such a method, comprising
means for performing such a method or for performing the steps of such a method; or comprising
a means of performing the step S1 which is connected or is connectable to the sender apparatus;
a means of performing the step S2;
a means of performing the step S3;
a means of performing the step S4;
a means of performing the step S5;
a means of performing the step S6; and
a means for performing the step S7 which is connected or is connectable to the apparatus.

The communication apparatus proposed in accordance with this aspect enables secure information technological and communication technological networking and data transmission between the sender apparatus and the apparatus. Furthermore, the use of a VPN for this data transmission can be dispensed with without jeopardizing the security of the data transmission.

In the context of the present invention, an expression of the type “an object to an activity” means in particular that the object serves for the activity, is suitable for the activity and/or is formed, adapted, designed or configured such that it performs or can perform the activity. For example, the expression “a means for performing step S1” means in particular that the means serves to perform step S1, is suitable for performing step S1 and/or is formed, adapted, designed or configured such that it performs or can perform step S1.

The invention proposes according to a fourth aspect a communication apparatus, in particular for use in a method such as one of the control methods proposed according to the second aspect, or for at least partially performing such a method, comprising
means for performing such a method or for performing the steps of such a method; or comprehensive
a means of performing the step S8 which is or can be connected to the sender apparatus;
a means of performing the step S9;
a means of performing the step S10;
a means of performing the step S11;
a means of performing the step S12;
a means of performing the step S13;
a means of performing the step S14; and
a means of performing the step S15 which is connectable or can be connected to the apparatus.

The communication apparatus proposed in accordance with this aspect enables secure information technological and communication technological networking and data transmission between the sender apparatus and the apparatus. Furthermore, the use of a VPN for this data transmission can be dispensed with without jeopardizing the security of the data transmission.

The communication apparatus proposed according to this aspect can be designed in any way as required, for example such that it additionally comprises
a means for performing step S1 which is connectable or can be connected to the sender apparatus; and
a means for performing step S3.

In an example embodiment of the invention, the communication apparatus comprises a means for performing step S16.

In an example embodiment of the invention, the communication apparatus comprises
a means of performing the step S17; and
a means of performing the step S18.

The invention proposes according to a fifth aspect a communication apparatus, in particular for use in a method which is formed like one of the control methods proposed according to the first aspect, or for at least partially performing such a method, comprising
at least one computer which is connectable or can be connected to the sender apparatus and the apparatus; and
at least one security module which is connected to the computer;
wherein
the first encryption key and the first identifier are stored in the computer;
the first certificate is stored in the security module;
the computer is configured to perform the step S1;
the computer and the security module are configured to perform step S2 wherein this performing is done by either
   the security module transmitting the first certificate to the computer, and
   the computer checking whether the first certificate is valid and whether the first encryption key in this certificate is assigned to the first identifier, and aborts the method if the result of this check is negative,
or by
   the computer transmitting the first encryption key and the first identifier to the security module, and
   the security module checking whether the first certificate is valid and whether the first encryption key in this certificate is assigned to the first identifier, and the computer aborts the method if the result of this check is negative;
the computer is configured to perform the steps S3, S4, S5, S6 and S7.

The communication apparatus proposed in accordance with this aspect enables a secure transmission between the sender apparatus and the apparatus. Furthermore, the use of a VPN for this data transmission can be dispensed with without jeopardizing the security of the data transmission.

In the context of the present invention, an expression of the type “an object is adapted to perform an activity” means in particular that the object serves to perform the activity, is suitable for performing the activity and/or is formed, adapted, designed or configured such that it performs or can perform the activity. For example, the expression “the computer is configured to perform step S1” means in particular that the computer serves to perform step S1, is suitable for performing step S1 and/or is formed, adapted, designed or configured such that it performs or can perform step S1.

The communication apparatus proposed according to this aspect may be formed in any manner as required, for example as one of the communication apparatus proposed according to the third aspect and/or such that it comprises no additional or at least one additional computer and/or no additional or at least one additional security module.

The invention proposes according to a sixth aspect, a communication apparatus, in particular for use in a method such as one of the control methods proposed according to the second aspect, or for at least partially performing out such a method, comprising
at least one computer which is or can be connected to the sender apparatus and the apparatus; and
at least one security module connected to the computer;
wherein
the first encryption key and the first identifier are stored in the computer;
the first certificate and the second decryption key are stored in the security module;
the computer is configured to perform the step S8;
the computer and the security module are configured to perform the step S9 wherein this execution is performed by either
   the security module transmitting the first certificate to the computer, and
   the computer checking whether the first certificate is valid and whether the first encryption key in this certificate is assigned to the first identifier, and aborts the method if the result of this check is negative,
or by
   the computer transmitting the first encryption key and the first identifier to the security module, and
   the security module checks whether the first certificate is valid and whether the first encryption key in this certificate is assigned to the first identifier, and the computer aborts the method if the result of this check is negative;
the computer and the security module are configured to perform step S10 wherein this performing is done by
   the computer transmitting the ciphertext to the security module,
   the security module decrypting the ciphertext using the second decryption key, whereby the plaintext is recovered, and
   the security module transmitting the recovered plain text to the computer;
the computer is configured to perform the steps S11, S12, S13, S14 and S15.

The communication apparatus proposed in accordance with this aspect enables secure information technological and communication technological networking and data transmission between the sender apparatus and the apparatus. Furthermore, the use of a VPN for this data transmission can be dispensed with without jeopardizing the security of the data transmission.

The communication apparatus proposed according to this aspect may be formed in any manner as required, for example as one of the communication apparatus proposed according to the fourth aspect, and/or such that it does not comprise an additional or at least one additional computer and/or does not comprise an additional or at least one additional security module, and/or such that the computer is configured to perform steps S1 and S3.

In an example embodiment of the invention,
the configuration file is stored in the computer;
the second certificate is stored in the security module; and
the computer and the security module are configured to perform the step S16 wherein this performing is done by either
   the security module transmitting the second certificate to the computer, and
   the computer checking whether the second certificate is valid and whether the configuration file has been signed using the second certificate, and the computer aborts the method if the result of this check is negative,
or by
   the computer transferring the configuration file to the security module, and
   the security module checking whether the second certificate is valid and whether the configuration file has been signed using the second certificate, and the computer aborts the method if the result of this check is negative.

In an example embodiment of the invention,
the third encryption key is stored in the computer; and
the computer is configured to perform step S7 or S15, wherein this performing is done by
   the computer encrypting the control command using the third encryption key, and
   the computer sending the encrypted control command to the apparatus.

In an example embodiment of the invention,
the second decryption key and/or the fourth decryption key is stored in the security module; and
the computer and the security module are adapted to execute step S7 or S15, wherein this performing is done by
   the computer transmitting the control command to the security module,
   the security module signing the control command using the second decryption key and/or the fourth decryption key, whereby a signature is generated,
   the security module transmitting the signature to the computer, and
   the computer sending the control command and the signature to the apparatus.

In an example embodiment of the invention,
the third encryption key is stored in the computer;
the second decryption key and/or the fourth decryption key is stored in the security module; and
the computer and the security module are configured to perform step S7 or S15, wherein this performing is done by
   the computer encrypting the control command using the third encryption key,
   the computer transmitting the control command or the encrypted control command to the security module,
   the security module signing the control command or the encrypted control command using the second decryption key and/or the fourth decryption key, whereby a signature is generated,
   the security module transmitting the signature to the computer, and
   the computer sending the encrypted control command and the signature to the apparatus.

In an example embodiment of the invention,
the third certificate is stored in the security module;
the computer is configured to perform the step S17 and
the computer and the security module are configured to perform the step S18 wherein this performing is done by either
   the security module transmitting the third certificate to the computer,
   the computer checking whether the third certificate is valid and whether the firmware has been signed using the third certificate, and aborts the method if the result of this check is negative, and
   the computer installing the firmware,
or by
   the computer transferring the firmware to the security module,
   the security module checking whether the third certificate is valid and whether the firmware has been signed using the third certificate, and the computer aborts the method if the result of this check is negative, and
   the computer installing the firmware.

This enables a secure over-the-air update.

In an example embodiment of the invention, a transmission of data from the computer to the security module and from the security module to the computer is protected by a transmission protection realized by software and/or hardware, which prevents the transmitted data from being read and/or modified and/or ensures that exclusively the computer can control this transmission of data and/or that this transmission of data can only take place with the aid of a password which is stored exclusively in the computer. In an example embodiment of the invention,
the security module has a write protection realized by software and/or hardware, which prevents an alteration of the first certificate stored in the security module, the second certificate stored in the security module, the second decryption key stored in the security module and/or the fourth decryption key stored in the security module; and/or
the security module has a read protection realized by software and/or hardware, which prevents a read of the second decryption key stored in the security module and/or the fourth decryption key stored in the security module.

In an example embodiment of the invention, the computer is configured for performing step S19.

In an example embodiment of the invention, the communication apparatus comprises
a first communication interface which is connectable or can be connected to the apparatus or to a communication interface of the apparatus; and/or
a second communication interface which is connectable or can be connected to the sender apparatus or to a communication interface of the sender apparatus.

The invention proposes according to a seventh aspect, a method of transmitting operating data of an apparatus to a receiver apparatus, wherein
a communication apparatus is connected or is being connected to the apparatus;
in a step B1 the communication apparatus receives the operating data from the apparatus;
in a step B2 the communication apparatus receives a second identifier associated with the receiver apparatus and a fifth encryption key using a valid fourth certificate and aborts the method if the result of this verification is negative;
in a step B3 the communication apparatus checks whether an authorization for receiving the operation data is assigned to the fifth encryption key and/or to the second identifier, and aborts the method if the result of this check is negative; and
in a step B4 the communication apparatus
   signs the operating data using a sixth decryption key associated with the communication apparatus, whereby a signature is generated, and
   sends the operating data and the signature to the receiver apparatus.

The method proposed in accordance with this aspect, which is also referred to as a transmission method in the context of the present invention, enables secure information technological and communication technological networking and data transmission between the apparatus and the receiver apparatus. Furthermore, the use of a VPN for this data transmission can be dispensed with without jeopardizing the security of the data transmission.

The receiver apparatus can be configured in any way as required and can, for example, comprise at least one measuring device, at least one machine, at least one computer, at least one production system, at least one technical system and/or at least one of the IIoT participants mentioned above and/or can form the sender apparatus.

The sending in step B4 can be carried out as required in any way, for example by the communication apparatus sending a file containing the operating data and a signature file containing the signature, or only a signature file containing the signature and the operating data as metadata, to the receiver apparatus. This transmission takes place via a VPN, for example.

The invention proposes according to an eighth aspect a method for sending operating data of an apparatus to a receiver apparatus, wherein
a communication apparatus is connected or is being connected to the apparatus;
in a step B5 the communication apparatus receives the operating data from the apparatus;
in a step B6 the communication apparatus verifies a second identifier associated with the receiver apparatus and a fifth encryption key using a valid fourth certificate and aborts the method if the result of this verification is negative;
in a step B7 the communication apparatus checks whether an authorization for receiving the operation data is assigned to the fifth encryption key and/or the second identifier, and
aborts the method if the result of this check is negative; and
in a step B8 the communication apparatus
   encrypts the operating data using the fifth encryption key;
   signs the operating data or the encrypted operating data using a sixth decryption key associated with the communication apparatus, whereby a signature is generated; and
   sends the encrypted operating data and the signature to the receiver apparatus.

The method proposed in accordance with this aspect, which is also referred to as a transmission method in the context of the present invention, enables secure information technological and communication technological networking and data transmission between the apparatus and the receiver apparatus. Furthermore, the use of a VPN for this data transmission can be dispensed with without jeopardizing the security of the data transmission.

The sending in step B8 can be carried out in any way as required, for example by the communication apparatus sending a file containing the encrypted operating data and a signature file containing the signature, or only a signature file containing the signature and the encrypted operating data as metadata, to the receiver apparatus. This transmission takes place via a VPN, for example.

The verification in steps B2 and B6 can be carried out in any way as required, for example by using the fourth certificate to check whether the fifth encryption key matches with the second identifier and/or by using at least one additional valid certificate.

The sixth decryption key may be formed in any manner as required, for example different from the second and/or the fourth decryption key or the same as the second and/or the fourth decryption key.

In an example embodiment of the invention, the apparatus
encrypts the operating data using a sixth encryption key, which corresponds to the sixth decryption key, or using a seventh encryption key associated with the communication apparatus, and
sends the encrypted operating data to the communication apparatus.

The seventh encryption key can be formed in any way as required, for example different from the second and/or the fourth and/or the sixth encryption key or the same as the second and/or the fourth and/or the sixth encryption key.

In an example embodiment of the invention, in a step B9 the communication apparatus decrypts the received encrypted operating data using the sixth decryption key or a seventh decryption key which corresponds to the seventh decryption key, whereby the operation data is restored.

The seventh decryption key may be formed in any way as required, for example different from the second and/or the fourth and/or the sixth decryption key or the same as the second and/or the fourth and/or the sixth decryption key.

In an example embodiment of the invention, the apparatus
signs the operating data using a eighth decryption key associated with the apparatus,
whereby a signature is generated, and
sends the operating data and the signature to the communication apparatus.

In an example embodiment of the invention, in a step B10 the communication apparatus verifies the received operating data and the received signature using an eighth encryption key which corresponds to the eighth decryption key and aborts the method if the result of this verification is negative.

The verification in step B10 can be carried out in any way as required, for example by using the eighth encryption key to check whether the received signature matches with the received operating data.

In an example embodiment of the invention, the apparatus
encrypts the operating data using a sixth encryption key corresponding to the sixth decryption key or using a seventh encryption key assigned to the communication apparatus,
sings the operating data or the encrypted operating data using an eighth decryption key associated with the apparatus, whereby a signature is generated, and
sends the encrypted operating data and the signature to the communication apparatus.

In an example embodiment of the invention, in a step B11 the communication apparatus decrypts the received encrypted operating data using the sixth decryption key or using a seventh decryption key corresponding to the seventh encryption key, whereby the operating data is recovered, and
verifies the received encrypted operating data and the received signature or the recovered operating data and the received signature using an eighth encryption key that corresponds to the eighth decryption key, and aborts the method if the result of this verification is negative.

The verification in step B11 may be performed in any way as required, for example by using the first encryption key to check whether the received signature matches with the received encrypted operating data or the recovered operating data.

In an exemplary embodiment of the invention, before sending according to step B4 or B8 in a step B12 an encrypted data connection is established between the communication apparatus and the receiver apparatus according to an encryption protocol.

In an example embodiment of the invention,
before step B1 or B5, a method such as one of the control methods proposed according to the first or second aspect is performed; and
the control instruction and/or the control command relates to the sending of operating data of the apparatus to the or a receiver apparatus or to the or a sender apparatus.

In an example embodiment of the invention,
at least one of the encryption keys is a public key of a key pair of an asymmetric cryptosystem and the respective decryption key is a private key of this key pair; or
at least one of the encryption keys and the respective decryption key are the same.

The invention proposes according to a ninth aspect, a communication apparatus, in particular for use in a method such as one of the transmission methods proposed according to the seventh aspect, or for at least partially performing such a method, comprising
means for performing such a method or for performing the steps of such a method; or comprising
a means of performing the step B1 which is connectable to or can be connected to the apparatus;
a means of performing the step B2;
a means of performing the step B3; and
a means of performing the step B4 which to be connected to the receiver apparatus.

The communication apparatus proposed according to this aspect enables secure information technological and communication technological networking and data transmission between the apparatus and the receiver apparatus. Furthermore, the use of a VPN for this data transmission can be dispensed with without jeopardizing the security of the data transmission.

The invention proposes according to a tenth aspect, a communication apparatus, in particular for use in a method such as one of the transmission methods proposed according to the eighth aspect, or for at least partially performing such a method, comprising
means for performing such a method or for performing the steps of such a method; or comprising
a means of performing the step B5 which is connectable or can be connected to the apparatus;
a means of performing the step B6;
a means of performing the step B7; and
a means of performing the step B8 which is connectable or can be connected to the receiver apparatus.

The communication apparatus proposed according to this aspect enables secure transmission between the apparatus and the receiver apparatus. Furthermore, the use of a VPN for this data transmission can be dispensed with without jeopardizing the security of the data transmission.

The communication apparatus proposed according to this aspect may be formed in any manner as required, for example such that it additionally comprises a means for performing step B4 which is connectable or can be connected to the receiver apparatus.

The invention proposes according to an eleventh aspect, a communication apparatus, in particular for use in a method such as one of the transmission methods proposed according to the seventh aspect, or for at least partially performing such a method, comprising
at least one computer which is connectable or can be connected to the apparatus and to the receiver apparatus; and
at least one security module which is connected to the computer;
whereby
the fifth encryption key and the second identifier are stored in the computer;
the fourth certificate is stored in the security module;
the second, the fourth, the sixth and/or the seventh decryption key is stored in the security module;
the computer is configured to perform the step B1;
the computer and the security module are configured to perform the step B2 wherein this performing is done by either
   the security module transmitting the fourth certificate to the computer, and
   the computer checking whether the fourth certificate is valid and whether in this certificate the fifth encryption key is assigned to the second identifier, and aborts the method if the result of this check is negative,
or by
   the computer transmitting the fifth encryption key and the second identifier to the security module, and
   the security module checking whether the fourth certificate is valid and whether in this certificate the fifth encryption key is assigned to the second identifier, and the computer aborts the method if the result of this check is negative;
the computer is configured to perform the step B3 and
the computer and the security module are configured to perform the step B4 wherein this performing is done by
   the computer transmitting the operating data to the safety module,
   the security module signing the operating data using the second, fourth, sixth and/or seventh decryption key, whereby a signature is generated,
   the security module transmitting the signature to the computer, and
   the computer sending the operating data and the signature to the receiver apparatus.

The communication apparatus proposed in accordance with this aspect enables secure information technological and communication technological networking and data transmission between the apparatus and the receiver apparatus. Furthermore, the use of a VPN for this data transmission can be dispensed with without jeopardizing the security of the data transmission.

The invention proposes according to a twelfth aspect, a communication apparatus, in particular for use in a method similar to one of the transmission methods proposed according to the second aspect, or for at least partially performing such a method, comprising
at least one computer which is connectable or can be connected to the apparatus and the receiver apparatus; and
at least one security module connected to the computer;
wherein
the fifth encryption key and the second identifier are stored in the computer;
the fourth certificate is stored in the security module;
the second, the fourth, the sixth and/or the seventh decryption key is stored in the security module;
the computer is configured to perform the step B5;
the computer and the security module are configured to perform the step B6 wherein this performing is done by either
   the security module transmitting the fourth certificate to the computer, and
   the computer checking whether the fourth certificate is valid and whether the fifth encryption key in this certificate is assigned to the second identifier, and aborts the method if the result of this check is negative,
or by
   the computer transmitting the fifth encryption key and the second identifier to the security module, and
   the security module checking whether the fourth certificate is valid and whether the fifth encryption key in this certificate is assigned to the second identifier, and the computer aborts the method if the result of this check is negative;
the computer is configured to perform the step B7; and
the computer and the security module are configured to perform the step B8 wherein this performing is done by
   the computer encrypting the operating data using the fifth encryption key,
   the computer transmitting the operating data or the encrypted operating data to the security module,
   the security module signing the operating data or the encrypted operating data using the second, the fourth, the sixth and/or the seventh decryption key, whereby a signature is generated,
   the security module transmitting the signature to the computer, and
   the computer sending the encrypted operating data and the signature to the receiver apparatus.

The communication apparatus proposed according to this aspect enables secure information technological and communication technological networking and data transmission between the apparatus and the receiver apparatus. Furthermore, the use of a VPN for this data transmission can be dispensed with without jeopardizing the security of the data transmission.

The invention proposes according to a thirteenth aspect, a computer program comprising instructions which, when executed by a computer or communication apparatus configured like one of the communication apparatus proposed according to the third, fourth, fifth, sixth, ninth, tenth, eleventh or twelfth aspect, cause said computer or communication apparatus to perform a method a method formed as one of the control methods proposed according to the first aspect, a method formed as one of the control methods proposed according to the second aspect, a method formed as one of the transmission methods proposed according to the seventh aspect, and/or a method formed as one of the transmission methods proposed according to the eighth aspect.

The invention proposes according to a fourteenth aspect, a computer-readable medium, on which a computer program formed as one of the computer programs proposed according to the thirteenth aspect is stored; and/or
comprising instructions which, when executed by a computer or communication apparatus configured like one of the communication apparatus proposed according to the third, fourth, fifth, sixth, ninth, tenth, eleventh or twelfth aspect, cause said computer or communication apparatus to perform a method a method formed as one of the control methods proposed according to the first aspect, a method formed as one of the control methods proposed according to the second aspect, a method formed as one of the transmission methods proposed according to the seventh aspect, and/or a method formed as one of the transmission methods proposed according to the eighth aspect.

The computer-readable medium can be configured as required, for example, in such a way that it comprises at least one computer-readable storage medium and/or at least one computer-readable data carrier.

The invention proposes according to a fifteenth aspect, a data carrier signal transmitting the computer program formed as one of the computer programs proposed according to the thirteenth aspect.

The invention proposes according to a sixteenth aspect, a method of setting up a communication apparatus, wherein
in a step E1 an owner of the apparatus generates a key pair comprising a public key and a private key by applying an asymmetric cryptosystem, wherein the public key forms the third encryption key and the private key forms the third decryption key;
in a step E2 the owner issues the first certificate for the first encryption key and sends it to the communication apparatus;
in a step E3 the first certificate is stored in a first memory area of the communication apparatus, in particular of the security module;
in a step E4 a write protection is activated for the first memory area;
in a step E5 the communication apparatus, in particular the security module, generates a key pair with a public key and a private key by using an asymmetric cryptosystem, wherein the public key forms the second encryption key and the private key forms the second decryption key;
in a step E6 the second decryption key is stored in a second memory area of the communication apparatus, in particular of the security module;
in a step E7 a write protection and a read protection for the second memory area can be activated;
in a step E8 the communication apparatus, in particular the security module, generates a certificate signing request for the second encryption key using the second decryption key;
in a step E9 the communication apparatus, in particular the computer, sends the certificate signing request to the owner;
in a step E10 the owner signs the certificate signing request using the third decryption key, resulting in a fifth certificate is issued for the second encryption key, and the fifth certificate to the communication apparatus;
in a step E11 either
   the fifth certificate is stored in a third memory area of the communication apparatus, in particular of the security module, and
   the communication apparatus, in particular the security module, verifies the fifth certificate using the first certificate and aborts the method if the result of this verification is negative,
or
   the communication apparatus, in particular the computer, verifies the fifth certificate using the first certificate and aborts the method if the result of this verification is negative, and
   the fifth certificate is stored in a third memory area of the communication apparatus, in particular of the security module;
in a step E12 a write protection is activated for the third memory area.

The method proposed according to this aspect, also referred to as a set-up method in the context of the present invention, enables a simple, secure and trustworthy set-up of the communication apparatus by the owner without the need for another party to be involved.

The communication apparatus may be formed in any manner as required, for example as one of the communication apparatus proposed according to the third, fourth, fifth or sixth aspect.

Verification in step E11 can be performed in any way as required, for example using at least one additional valid certificate.

The invention proposes according to a seventeenth aspect, the invention proposes a method of setting up a communication apparatus, wherein
in a step E13 an owner of the apparatus generates a key pair comprising a public key and a private key by applying an asymmetric cryptosystem, wherein the public key forms the third encryption key and the private key forms the third decryption key;
in a step E14 the owner issues the first certificate for the first encryption key and sends it to the communication apparatus;
in a step E15 a manufacturer of the apparatus generates a key pair having a public key and a private key by applying an asymmetric cryptosystem, wherein the public key has a nineth encryption key and the private key having a nineth decryption key;
in a step E16 the manufacturer can add a sixth certificate for the first encryption key and sends it to the communication apparatus;
in a step E17 the first certificate and the sixth certificate are stored in a first memory area of the communication apparatus, in particular of the security module;
in a step E18 a write protection is activated for the first memory area;
in a step E19 the communication apparatus, in particular the security module, generates a key pair with a public key and a private key by using an asymmetric cryptosystem, wherein the public key forms the second encryption key and the private key forms the second decryption key;
in a step E20 the second decryption key is stored in a second memory area of the communication apparatus, in particular of the security module;
in a step E21 a write protection and a read protection are activated for the second memory area;
in a step E22 the communication apparatus, in particular the security module, generates a certificate signing request for the second encryption key using the second decryption key;
in a step E23 the communication apparatus, in particular the computer, sends the certificate signing request to the owner;
in a step E24 the owner signs the certificate signing request using the third decryption key, thereby issuing a fifth certificate for the second encryption key, and sends the fifth certificate to the communication apparatus;
in a step E25 the communication apparatus, in particular the computer, sends the certificate signing request to the manufacturer;
in a step E26 the manufacturer signs the certificate signing request using the nineth decryption key, whereby a seventh certificate is issued for the second encryption key, and sends the seventh certificate to the communication apparatus;
in a step E27 either
   the fifth certificate and the seventh certificate are stored in a third memory area of the communication apparatus, in particular of the security module, and
   the communication apparatus, in particular the safety module,
      verifies the fifth certificate using the first certificate and aborts the method if the result of this verification is negative, and
      verifies the seventh certificate using the sixth certificate and aborts the method if the result of this verification is negative,
   or
   the communication apparatus, in particular the computer,
      verifies the fifth certificate using the first certificate and aborts the method if the result of this verification is negative,
      verifies the seventh certificate using the sixth certificate and aborts the method if the result of this verification is negative, and
      the fifth certificate and the zeroth certificate are being stored in a third memory area of the communication apparatus, in particular of the security module;
in a step E28 a write protection is activated for the third memory area.

The method proposed according to this aspect, also referred to as the set-up method in the context of the present invention, enables a simple, secure and trustworthy set-up of the communication apparatus by the owner and the manufacturer without the need for any other party to be involved.

The communication apparatus may be formed in any manner as required, for example as one of the communication apparatus proposed according to the third, fourth, fifth or sixth aspect.

Each verification in step E27 may be performed in any manner as required, for example using at least one additional valid certificate.

In an exemplary embodiment of the invention,
in a step E29 the owner checks whether the first certificate stored in the first storage area is unchanged, and aborts the method if the result of this check is negative; and/or
in a step E30 the manufacturer checks whether the sixth certificate stored in the first storage area is unchanged, and aborts the method if the result of this check is negative;
and/or
in a step E31 the owner verifies the certificate signing request and the fifth certificate stored in the third storage area using the third encryption key and aborts the method if the result of this verification is negative; and/or
in a step E32 the manufacturer verifies the certificate signing request and the seventh certificate stored in the third storage area using the ninth encryption key and aborts the method if the result of this verification is negative; and/or
in a step E33 the owner checks whether the second decryption key stored in the second memory area has been generated by the security module, and aborts the method if the result of this check is negative; and/or
in a step E34 the manufacturer checks whether the second decryption key stored in the second memory area has been generated by the security module, and aborts the method if the result of this check is negative.

The verification in step E31 may be performed in any manner as required, for example, using the third encryption key to verify that the fifth certificate matches with the certificate signing request and has been signed with the third decryption key.

The verification in step E32 may be performed in any manner as required, for example by using the ninth encryption key to verify that the seventh certificate matches with the certificate signing request and has been signed with the ninth decryption key.

The invention proposes according to an eighteenth aspect, the invention proposes a method of setting up a communication apparatus, wherein
in a step F1 a owner of the apparatus generates a key pair comprising a public key and a private key by applying an asymmetric cryptosystem, wherein the public key forms the third encryption key and the private key forms the third decryption key;
in a step F2 the owner issues the fourth certificate for the fifth encryption key and sends it to the communication apparatus;
in a step F3 the fourth certificate is stored in a fourth memory area of the communication apparatus or of the security module;
in a step F4 a write protection is activated for the fourth memory area;
in a step F5 the communication apparatus or the security module generates a key pair with a public key and a private key by applying an asymmetric cryptosystem, wherein the public key forms the second encryption key and the private key forms the second decryption key;
in a step F6 the second decryption key is stored in a second memory area of the communication apparatus or of the security module;
in a step F7 write protection and read protection for the second memory area are activated;
in a step F8 the communication apparatus or the security module generates a certificate signing request for the second encryption key using the second decryption key;
in a step F9 the communication apparatus or computer sends the certificate signing request to the owner;
in a step F10 the owner signs the certificate signing request using the third decryption key, whereby a fifth certificate for the second encryption key is issued, and sends the fifth certificate to the communication apparatus;
in a step F11 either
   the fifth certificate is stored in a third memory area of the communication apparatus or security module, and
   the communication apparatus or the security module verifies the fifth certificate using the fourth certificate and aborts the method if the result of this verification is negative,
or
   the communication apparatus or computer verifies the fifth certificate using the fourth certificate and aborts the method if the result of this verification is negative, and
   the fifth certificate is being stored in a third memory area of the communication apparatus or the security module;
in a step F12 write protection is activated for the third memory area.

The method proposed according to this aspect, also referred to as a set-up method in the context of the present invention, enables a simple, secure and trustworthy set-up of the communication apparatus by the owner without the need for another party to be involved.

The communication apparatus may be formed in any manner as required, for example as one of the communication apparatus proposed according to the ninth, tenth, eleventh or twelfth aspect.

Verification in step F11 can be carried out in any way as required, for example using at least one additional valid certificate.

The invention proposes according to a nineteenth aspect, the invention proposes a method of setting up a communication apparatus, wherein
in a step F13 an owner of the apparatus generates a key pair comprising a public key and a private key by applying an asymmetric cryptosystem, wherein the public key forms the third encryption key and the private key forms the third decryption key;
in a step F14 the owner issues the fourth certificate for the fifth encryption key and sends it to the communication apparatus;
in a step F15 a manufacturer of the apparatus generates a key pair comprising a public key and a private key by applying an asymmetric cryptosystem, wherein the public key forms a ninth encryption key and the private key forms a ninth decryption key;
in a step F16 the manufacturer issues an eighth certificate for the fifth encryption key and sends it to the communication apparatus;
in a step F17 the fourth certificate and the eighth certificate are stored in a fourth memory area of the communication apparatus or of the security module;
in a step F18 a write protection is activated for the fourth memory area;
in a step F19 the communication apparatus or the security module generates a key pair comprising a public key and a private key by applying an asymmetric cryptosystem,
wherein the public key forms the second encryption key and the private key forms the second decryption key;
in a step F20 the second decryption key is stored in a second memory area of the communication apparatus or the security module;
in a step F21 to activate write protection and read protection for the second memory area;
in a step F22 the communication apparatus or the security module generates a certificate signing request for the second encryption key using the second decryption key;
in a step F23 the communication apparatus or computer sends the certificate signing request to the owner;
in a step F24 the owner signs the certificate signing request using the third decryption key, thereby issuing a fifth certificate for the second encryption key, and sends the fifth certificate to the communication apparatus;
in a step F25 the communication apparatus or computer sends the certificate signing request to the manufacturer;
in a step F26 the manufacturer signs the certificate signing request using the nineth decryption key, whereby a seventh certificate for the second encryption key is issued, and sends the seventh certificate to the communication apparatus;
in a step F27 either
   the fifth certificate and the seventh certificate are stored in a third memory area of the communication apparatus or of the security module, and
   the communication apparatus or the safety module
      verifies the fifth certificate using the fourth certificate and aborts the method if the result of this verification is negative, and
      verifies the seventh certificate using the eighth certificate and aborts the method if the result of this verification is negative,
or
   the communication apparatus or the computer
      verifies the fifth certificate using the fourth certificate and aborts the method if the result of this verification is negative,
      verifies the seventh certificate using the eighth certificate and aborts the method if the result of this verification is negative, and
      the fifth certificate and the seventh certificate are stored in a third memory area of the communication apparatus or the security module;
in a step F28 a write protection is activated for the third memory area.

The method proposed according to this aspect, also referred to as a set-up method in the context of the present invention, enables a simple, secure and trustworthy set-up of the communication apparatus by the owner and the manufacturer without the need for any other party to be involved.

The communication apparatus may be formed in any manner as required, for example as one of the communication apparatus proposed according to the ninth, tenth, eleventh or twelfth aspect.

Each verification in step F27 may be performed in any manner as required, for example using at least one additional valid certificate.

In an exemplary embodiment of the invention,
in a step F29 the owner checks whether the fourth certificate stored in the fourth storage area is unchanged, and aborts the method if the result of this check is negative; and/or
in a step F30 the manufacturer checks whether the eighth certificate stored in the fourth storage area is unchanged and aborts the method if the result of this check is negative;
and/or
in a step F31 the owner verifies the certificate signing request and the fifth certificate stored in the third storage area using the third encryption key and aborts the method if the result of this verification is negative; and/or
in a step F32 the manufacturer verifies the certificate signing request and the seventh certificate stored in the third storage area using the ninth encryption key and aborts the method if the result of this verification is negative; and/or
in a step F33 the owner checks whether the second decryption key stored in the second memory area has been generated by the security module, and aborts the method if the result of this check is negative; and/or
in a step F34 the manufacturer checks whether the second decryption key stored in the second memory area has been generated by the security module and aborts the method if the result of this check is negative.

The verification in step F31 can be performed in any way as required, for example by using the third encryption key to check whether the fifth certificate matches with the certificate signing request and has been signed with the third decryption key.

The verification in step E32 may be performed in any manner as required, for example by using the ninth encryption key to verify that the seventh certificate matches with the certificate signing request and has been signed with the ninth decryption key.

The invention proposes according to a twentieth aspect, the invention proposes a system comprising
at least one sender apparatus;
at least one apparatus; and
at least one communication apparatus configured as one of the communication apparatus proposed according to the third, fourth, fifth or sixth aspect and connected to the at least one sender apparatus and the at least one apparatus.

For example, the system may comprise, as required, no additional or at least one additional sender apparatus, no additional or at least one additional apparatus and/or no additional or at least one additional communication apparatus configured as one of the communication apparatus proposed according to the third, fourth, fifth or sixth aspect and connected to at least one of the sender apparatus and at least one of the apparatus.

The invention proposes according to a twenty-first aspect, the invention proposes a system comprising
at least one receiver apparatus;
at least one apparatus; and
at least one communication apparatus configured as one of the communication apparatus proposed according to the ninth, tenth, eleventh or twelfth aspect and connected to the at least one receiver apparatus and the at least one apparatus.

In an exemplary embodiment of this aspect,
the system comprises at least one sender apparatus;
at least one of the communication apparatus is configured as one of the communication apparatus proposed according to the third, fourth, fifth or sixth aspect and is connected to the at least one sender apparatus.

For example, the system may comprise no additional or at least one additional receiver apparatus, no additional or at least one additional apparatus, no additional or at least one additional sender apparatus and/or no additional or at least one additional communication apparatus configured like one of the communication apparatus proposed according to the ninth, tenth, eleventh or twelfth aspect and connected to at least one of the receiver apparatus and at least one of the apparatus and optionally configured like one of the communication apparatus proposed according to the third, fourth, fifth or sixth aspect and/or connected to at least one of the sender apparatus.

In an exemplary embodiment of the invention, the system comprises
at least one sender apparatus;
at least one communication apparatus configured as one of the communication apparatus proposed according to the third, fourth, fifth or sixth aspect and connected to the at least one sender apparatus.

For example, the system may comprise no additional or at least one additional sender apparatus and/or no additional or at least one additional communication apparatus configured as one of the communication apparatus proposed according to the third, fourth, fifth or sixth aspect and connected to at least one of the sender apparatus.

Each apparatus, each sender apparatus and each receiver apparatus may be formed in any manner as required and may each comprise, for example, at least one measuring device, at least one machine, at least one computer, at least one production plant, at least one technical system and/or at least one of the aforementioned IIoT participants. Each sender apparatus may, for example, form one of the receiver apparatus, and each receiver apparatus may, for example, form one of the sender apparatus.

Each identifier can be formed in any way as required and can include, for example, an e-mail, serial number and/or personnel number.

Each certificate can be formed in any way as required, for example as a root certificate or intermediate certificate and/or as a public key certificate or attribute certificate. In particular, a certificate is valid if it has neither been revoked nor expired.

Each computer can be configured in any way as required, for example as a single-board computer and/or in such a way that it and at least one of the security modules are integrated in a system-on-a-chip, or “SoC” for short, are inseparably connected to each other, are soldered to a common circuit board, are sealed together and/or are cast together. Each security module can be designed as required in any way, for example according to the FIPS 140-2 standard, according to the TrustZone technology of Arm Ltd. such as a YubiKey and/or in such a way that it comprises at least one YubiKey.

Each transmission protection, each write protection and each read protection can be realized in any way as required, for example according to the FIPS 140-2 standard, according to the TrustZone technology of Arm Ltd, according to the Secure Channel specification of Yubico Ltd. and/or as realized in a YubiKey, and/or by comprising bus encyption, a challenge-response method and/or an asymmetric cryptosystem, and/or by the respective computer and the respective security module being inseparably connected, soldered on a common circuit board, individually or jointly sealed and/or jointly cast.

Each seal can for example be made in such a way that the computer and the security module are each connected to a common circuit board or another component by a separate seal or are connected to each other by a common seal. Each seal can be formed in any way required, for example as an adhesive label or screw locking varnish or sealing varnish. Any casting can be carried out, for example, using casting resin that connects and/or encloses the computer and the security module as completely as possible.

Each asymmetric cryptosystem can be formed in any way as required, for example according to the RSA cryptosystem, the Elgamal cryptosystem or the ECC cryptosystem.

Each proposed method may be combined with at least one of the other proposed methods and/or may be formed in any manner as required, for example as a computer-implemented method.

Each proposed communication apparatus may be combined with at least one of the other proposed communication apparatus and/or may be configured in any manner as required, for example such that it is a computer or comprises at least one computer and/or is configured to perform at least part of at least one of the proposed methods.

Each proposed system can be combined with at least one of the other proposed systems.

The explanations relating to one of the aspects of the invention, in particular to individual features of this aspect, also apply analogously to the other aspects of the invention.

In the following, embodiments of the invention are explained in more detail by way of example with reference to the accompanying drawings. However, the individual features resulting therefrom are not limited to the individual embodiments, but can be connected and/or combined with individual features described further above and/or with individual features of other embodiments. The details in the drawings are only to be interpreted as explanatory, but not restrictive. The reference signs contained in the claims are not intended to limit the scope of protection of the invention in any way, but merely refer to the embodiments shown in the drawings.

The drawings show in

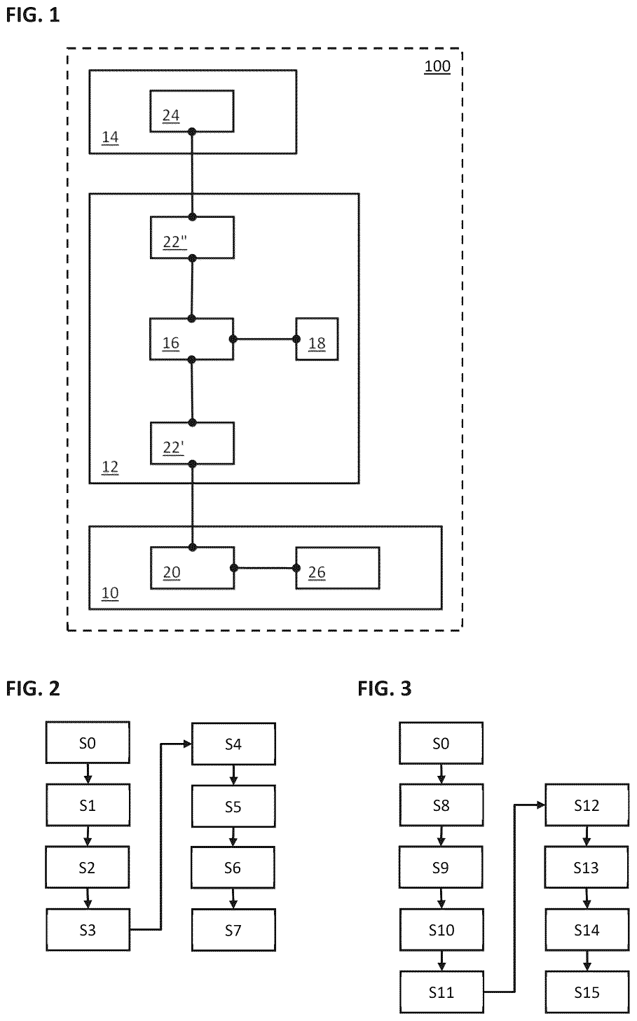

FIG. 1 a block diagram of a first embodiment of a system, the system comprising a sender apparatus, a apparatus and a first embodiment of a communication apparatus for use in a control method for controlling the apparatus;

FIG. 2 a first embodiment of a control method for controlling a apparatus, in particular the apparatus of FIG. 1;

FIG. 3 a second embodiment of the control method for controlling a apparatus, in particular the apparatus of FIG. 1;

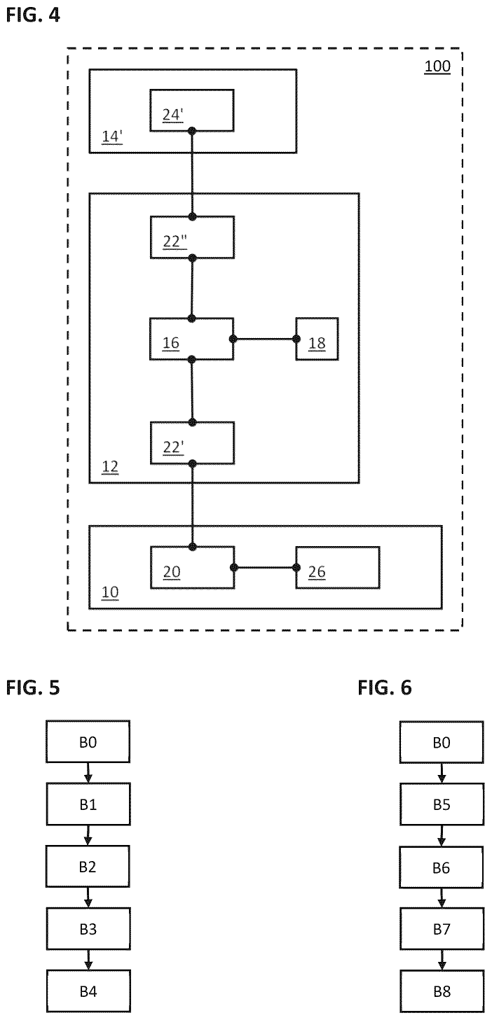

FIG. 4 a block diagram of a second embodiment of a system, the system comprising a receiver apparatus, a apparatus and a second embodiment of a communication apparatus for use in a transmission method for transmitting operating data of the apparatus to the receiver apparatus;

FIG. 5 a first embodiment of a transmission method for transmitting operating data of a apparatus to a receiver apparatus, in particular the apparatus of FIG. 4 to the receiver apparatus;

FIG. 6 a second embodiment of the transmission method for transmitting operating data of a apparatus to a receiver apparatus, in particular the apparatus of FIG. 4 to the receiver apparatus;

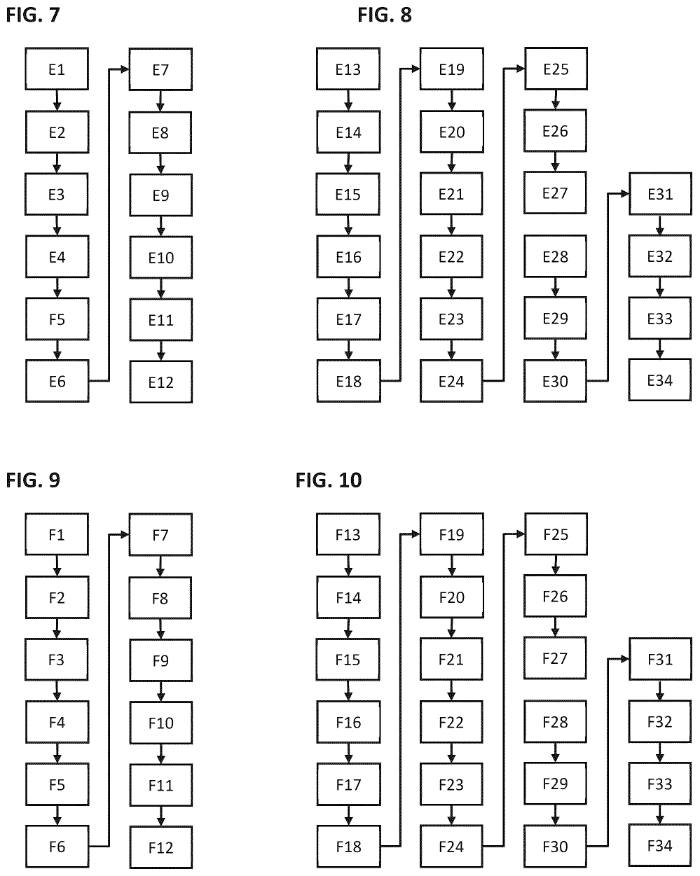

FIG. 7 a first embodiment of a set-up method for setting up a communication apparatus, in particular the communication apparatus of FIG. 1;

FIG. 8 a second embodiment of the set-up method for setting up a communication apparatus, in particular the communication apparatus of FIG. 1;

FIG. 9 a third embodiment of a set-up method for setting up a communication apparatus, in particular the communication apparatus of FIG. 4 and

FIG. 10 a fourth embodiment of the set-up method for setting up a communication apparatus, in particular the communication apparatus of FIG. 4.

In FIG. 1 a first embodiment of a system 100 is schematically shown, comprising a technical apparatus 10, a communication apparatus 12 formed according to a first embodiment, and a sender apparatus 14.

The apparatus 10 comprises, by way of example, a CNC machine 26 and a communication interface 20 which is connected to the CNC machine 26 and forms, by way of example, a USB interface.

The sender apparatus 14 forms, by way of example, a laptop and comprises a communication interface 24, which forms, by way of example, a radio interface.

The communication apparatus 12 comprises a computer 16, a security module 18, which exemplarily forms a hardware security module, a first communication interface 22′, which exemplarily forms a USB interface corresponding to the communication interface 20, and a second communication interface 22″, which exemplarily forms a radio interface corresponding to the communication interface 24. The computer 16 is connected to the security module 18 and the communication interfaces 22′, 22″. The first communication interface 22′ is connected to the communication interface 20. The second communication interface 22″ is connected to the communication interface 24.

In FIG. 2 a first embodiment of a control method for controlling a apparatus is shown schematically, wherein with this embodiment the apparatus 10 of FIG. 1 is or can be controlled with the aid of the communication apparatus 12. The apparatus 10, the communication apparatus 12 and the sender apparatus 14 are designed in such a way that they can perform this control method.

In a step S0, the communication apparatus 12 is connected to the apparatus 10 by means of the communication interfaces 22′, 20 and to the sender apparatus 14 by means of the communication interface 22″, 24.

In a step S1 which follows step S0, the communication apparatus 12 receives a plaintext and a signature from the sender apparatus 14 with the aid of the computer 16.

In a step S2 which follows step S1 the communication apparatus 12 uses the computer 16 and the security module 18 to verify the first identifier ID1 associated with the sender apparatus 14 and stored in the computer 16, using the valid first certificate Z1 stored in the security module 18. The computer 16 aborts the method if the result of this verification is negative.

In a step S3 which is based on step S2 the communication apparatus 12 verifies the received signature and the received plaintext with the aid of the computer 16 using the first encryption key CS1 stored in the computer 16. The computer 16 aborts the method if the result of this verification is negative.

In a step S4 which is based on step S3 the communication apparatus 12 uses the computer 16 to check whether a control instruction for the apparatus 10 is contained in the plain text. The computer 16 aborts the method if the result of this check is negative.

In a step S5 which is based on step S4 the communication apparatus 12 uses the computer 16 to check whether an authorization for the control instruction is assigned to the first encryption key CS1 and the first identifier ID1. The computer 16 aborts the method if the result of this check is negative.

In a step S6 which follows step S5 the communication apparatus generates, with the aid of the computer 16, a control command for the apparatus 10 using the control instruction contained in the recovered plaintext.

In a step S7 which is based on step S6 the communication apparatus 12 uses the computer 16 to send the control command to the apparatus 10, thereby controlling the apparatus 10.

In FIG. 3 a second embodiment of the control method for controlling a apparatus is shown schematically, which is similar to the first embodiment, so that the differences are explained in more detail below. The apparatus 10, the communication apparatus 12 and the sender apparatus 14 are designed in such a way that they can perform this control method.

In a step S8 which follows step S0, the communication apparatus 12 receives a ciphertext and a signature from the sender apparatus 14 with the aid of the computer 16 instead of a plaintext, the ciphertext representing an encrypted plaintext.

In a step S9 which follows step S8 the communication apparatus 12 verifies, with the aid of the computer 16 and the security module 18, the second identifier ID2, which is assigned to the sender apparatus 14 and stored in the computer 16 and, by way of example, is identical to the first identifier ID1, and the ninth encryption key CS9, which is stored in the computer 16, using the valid eighth certificate Z8, which is stored in the security module 18 and, by way of example, is identical to the first certificate Z1. The computer 16 aborts the method if the result of this verification is negative.

In a step S10 which follows step S9 the communication apparatus 12, with the aid of the computer 16 and the security module 18, decrypts the received ciphertext using the second decryption key DC2 associated with the communication apparatus 12 and stored in the security module 18, thereby restoring the plaintext.

In a step S11 which follows step S10 the communication apparatus 12 uses the computer 16 to verify the received signature and, instead of the received plaintext, the received ciphertext using the first encryption key CS1 stored in the computer 16. The computer 16 aborts the method if the result of this verification is negative.

A step S12 that follows step S11 corresponds to step S4. A step S13 that follows step S12 corresponds to step S5. A step S14 that follows step S13 corresponds to step S6. A step S15 that follows step S14 corresponds to step S7.

In FIG. 4 a second embodiment of the system 100 is shown schematically. This embodiment is similar to the first embodiment, so that the differences will be explained in more detail below. In this embodiment, the system 100 comprises a receiver apparatus 14′ instead of the sender apparatus 14, and the communication apparatus 12 is formed according to a second embodiment which is similar to the first embodiment, so that in the following, mainly the differences will be explained in more detail.

The receiver apparatus 14′ forms, by way of example, a laptop and comprises a communication interface 24′, which forms, by way of example, a radio interface.

The second communication interface 22″ forms an exemplary radio interface corresponding to the communication interface 24′. The second communication interface 22″ is connected to the communication interface 24′.

In FIG. 5 a first embodiment of a transmission method for transmitting operating data of a apparatus to a receiver apparatus is shown schematically, wherein with this embodiment exemplary operating data of the apparatus 10 of FIG. 4 can be transmitted to the receiver apparatus 14′ of FIG. 4 with the aid of the communication apparatus 12. The apparatus 10, the communication apparatus 12 and the receiver apparatus 14′ are designed in such a way that they can carry out this transmission method.

In a step B0, the communication apparatus 12 is connected to the apparatus 10 by means of the communication interfaces 22′, 20 and to the receiver apparatus 14′ by means of the communication interface 22″, 24′.

In a step B1 which follows step B0, the communication apparatus 12 receives the operating data from the apparatus 10 with the aid of the computer 16.

In a step B2 which is based on step B1 the communication apparatus 12 verifies, with the aid of the computer 16 and the security module 18, the second identifier ID2 associated with the receiver apparatus 14′ and stored in the computer 16, and the fifth encryption key CS5 stored in the computer 16, using the valid fourth certificate Z4 stored in the security module 18. The computer 16 aborts the method if the result of this verification is negative.

In a step B3 which is based on step B2 the communication apparatus 12 uses the computer 16 to check whether an authorization for receiving the operating data is assigned to the fifth encryption key CS5 and the second identifier ID2. The computer 16 aborts the method if the result of this check is negative.

In a step B4 which is based on step B3 the communication apparatus 12, with the aid of the security module 18, signs the operating data using the sixth decryption key associated with the communication apparatus 12 and stored in the security module 18, thereby generating a signature. The communication apparatus 12 then uses the computer 16 to send the operating data and the signature to the receiver apparatus 14′.

In FIG. 6 a second embodiment of the transmission method for transmitting operating data of a apparatus to a receiver apparatus is schematically shown, which is similar to the first embodiment, so that in the following mainly the differences are explained in more detail. The apparatus 10, the communication apparatus 12 and the receiver apparatus 14′ are configured in such a way that they can perform this transmission method.

A step B5 that follows step B0 corresponds to step B1. A step B6 that follows step B5 corresponds to step B2. A step B7 that follows step B6 corresponds to step B3.

In a step B8 which is based on step B7 the communication apparatus 12 encrypts the operating data using the fifth encryption key CS5 with the aid of the computer 16. Then, the communication apparatus 12 signs the encrypted operating data using the sixth decryption key associated with the communication apparatus 12 and stored in the security module 18 instead of the operating data, thereby generating a signature. The communication apparatus 12 then uses the computer 16 to send the encrypted operating data and the signature to the receiver apparatus 14′ instead of the operating data.

In FIG. 7 a first embodiment of a set-up method for setting up a communication apparatus is shown schematically, whereby this embodiment can be used to set up the communication apparatus 12 of FIG. 1 as an example.

In a step E1 a owner of the apparatus 10 generates a key pair with a public key and a private key by applying an asymmetric cryptosystem, wherein the public key forms the third encryption key CS3 and the private key forms the third decryption key DS3.

In a step E2 which is based on step E1 the owner issues the first certificate Z1 for the first encryption key CS1 and sends it to the communication apparatus 12.

In a step E3 which is based on step E2 the computer 16 stores the first certificate Z1 in a first memory area of the security module 18.

In a step E4 which is based on step E3 the computer 16 activates write protection for the first memory area.

In a step E5 which is based on step E4 the security module 18 generates a key pair with a public key and a private key by using an asymmetric cryptosystem, wherein the public key forms the second encryption key CS2 and the private key forms the second decryption key DS2.

In a step E6 which is based on step E5 the security module 18 stores the second decryption key DS2 in a second memory area of the security module 18.

In a step E7 which is based on step E6 the security module 18 or the computer 16 activates write protection and read protection for the second memory area.

In a step E8 which is based on step E7 the security module 18 generates a certificate signing request for the second encryption key CS2 using the second decryption key DS2.

In a step E9 which is based on step E8 the computer 16 sends the certificate signing request to the owner.

In a step E10 which is based on step E9 the owner signs the certificate signing request using the third decryption key DS3, thereby issuing a fifth certificate Z5 for the second encryption key CS2, and sends the fifth certificate Z5 to the communication apparatus 12.

In a step E11 which is based on step E10 the computer 16 stores the fifth certificate Z5 in a third memory area of the security module 18. The security module 18 then verifies the fifth certificate Z5 using the first certificate Z1 and aborts the method if the result of this verification is negative.

In an alternative step E11 the computer 16 verifies the fifth certificate Z5 using the first certificate Z1 and aborts the method if the result of this verification is negative. The computer 16 then stores the fifth certificate Z5 in a third memory area of the security module 18.

In a step E12 which is based on step E11 the security module 18 or the computer 16 activates write protection for the third memory area.

Now the communication apparatus 12 is set up and can be used in the control methods of FIG. 2 and FIG. 3.

In FIG. 8 a second embodiment of the setup method for setting up a communication apparatus is shown schematically, which is similar to the first embodiment, so that the differences are explained in more detail below.

A step E13 corresponds to step E1. A step E14 which corresponds to step E13 corresponds to step E2.

In a step E15 which follows step E14 a manufacturer of the apparatus 10 generates a key pair comprising a public key and a private key by applying an asymmetric cryptosystem, wherein the public key forms a ninth cipher key CS9 and the private key forms a ninth decipher key DS9.

In a step E16 which is based on step E15 the manufacturer issues a sixth certificate Z6 for the first encryption key CS1 and sends it to the communication apparatus 12.

In a step E17 which follows step E16 the computer 16 stores the first certificate Z1 and the sixth certificate Z6 in a first memory area of the security module 18.

A step E18 which is based on step E17 corresponds to step E4. A step E19 that follows step E18 corresponds to step E5. A step E20 that follows step E19 corresponds to step E6. A step E21 that follows step E20 corresponds to step E7. A step E22 that follows step E21 corresponds to step E8. A step E23 that follows step E22 corresponds to step E9. A step E24 that follows step E23 corresponds to step E10. In a step E25 which follows step E24 the computer 16 sends the certificate signing request to the manufacturer.

In a step E26 which follows step E25 the manufacturer signs the certificate signing request using the ninth decryption key DS9, thereby issuing a seventh certificate Z7 for the second encryption key CS2, and sends the seventh certificate Z7 to the communication apparatus 12.

In a step E27 which is based on step E26 the computer 16 stores the fifth certificate Z5 and the seventh certificate Z7 in a third memory area of the security module 18. The security module 18 then verifies the fifth certificate Z5 using the first certificate Z1 and aborts the method if the result of this verification is negative. In addition, the security module 18 verifies the seventh certificate Z7 using the sixth certificate Z6 and aborts the method if the result of this verification is negative.

In an alternative step E27 the computer 16 verifies the fifth certificate Z5 using the first certificate Z1 and aborts the method if the result of this verification is negative. In addition, the computer 16 verifies the seventh certificate Z7 using the sixth certificate Z6 and aborts the method if the result of this verification is negative. The computer 16 then stores the fifth certificate Z5 and the seventh certificate Z7 in a third memory area of the security module 18.

A step E28 that follows step E27 corresponds to step E12.

Now, the communication apparatus 12 is set up and can be used in the control methods of FIG. 2 and FIG. 3. With the following exemplary steps, the established communication apparatus 12 is checked by both the owner and the manufacturer.

In a step E29 which follows step E28 the owner checks whether the first certificate Z1 stored in the first memory area is unchanged and aborts the method if the result of this check is negative.

In a step E30 which follows step E29 the manufacturer checks whether the sixth certificate Z6, which is stored in the first memory area, is unchanged, and aborts the method if the result of this check is negative.

In a step E31 which follows step E30 the owner verifies the certificate signing request and the fifth certificate Z5 stored in the third storage area using the third encryption key CS3 and aborts the method if the result of this verification is negative.

In a step E32 which follows step E31 the manufacturer verifies the certificate signing request and the seventh certificate Z7 stored in the third memory area using the ninth encryption key CS9 and aborts the method if the result of this verification is negative.

In a step E33 which is based on step E32 the owner checks whether the second decryption key DS2 stored in the second memory area has been generated by the security module 18, and aborts the method if the result of this check is negative.

In a step E34 which follows step E33 the manufacturer checks whether the second decryption key DS2, which is stored in the second memory area, has been generated by the security module 18, and aborts the method if the result of this check is negative.

Now the communication apparatus 12 set up has been checked by both the owner and the manufacturer.

In FIG. 9 a third embodiment of a set-up method for setting up a communication apparatus is shown schematically, whereby this embodiment can be used to set up the communication apparatus 12 of FIG. 4 as an example. This embodiment is similar to the first embodiment, so that the differences will be explained in more detail below.

A step F1 corresponds to step E1.

In a step F2 which follows step F1 the owner issues the fourth certificate Z4 for the fifth encryption key CS5 and sends it to the communication apparatus 12.

In a step F3 which is based on step F2 the computer 16 stores the fourth certificate Z4 in a fourth memory area of the security module 18.

In a step F4 which follows step F3 the computer 16 activates write protection for the fourth memory area.

A step F5 that follows step F4 corresponds to step E5. A step F6 that follows step F5 corresponds to step E6. A step F7 that follows step F6 corresponds to step E7. A step F8 that follows step F7 corresponds to step E8. A step F9 that follows step F8 corresponds to step E9. A step F10 that follows step F9 corresponds to step E10.

In a step F11 which follows step F10 the computer 16 stores the fifth certificate Z5 in a third memory area of the security module 18. The security module 18 then verifies the fifth certificate Z5 using the fourth certificate Z4 and aborts the method if the result of this verification is negative.

In an alternative step F11 the computer 16 verifies the fifth certificate Z5 using the fourth certificate Z4 and aborts the method if the result of this verification is negative. The computer 16 then stores the fifth certificate Z5 in a third memory area of the security module 18.

A step F12 that follows step F11 corresponds to step E12.

Now the communication apparatus 12 is set up and can be used in the transmission methods of FIG. 5 and FIG. 6.

In FIG. 10 a fourth embodiment of the setup method for setting up a communication apparatus is shown schematically, which is similar to the third embodiment, so that the differences in particular are explained in more detail below.

A step F13 corresponds to step F1. A step F14 which corresponds to step F13 corresponds to step F2. F15 that follows step F14 corresponds to step E15.

In a step F16 which follows step F15 the manufacturer issues an eighth certificate Z8 for the fifth encryption key CS5 and sends it to the communication apparatus 12.

In a step F17 which follows step F16 the computer 16 stores the fourth certificate Z4 and the eighth certificate Z8 in a fourth memory area of the security module 18.

A step F18 that follows step F17 corresponds to step F4. A step F19 that follows step F18 corresponds to step F5. A step F20 that follows step F19 corresponds to step F6. A step F21 that follows step F20 corresponds to step F7. A step F22 that follows step F21 corresponds to step F8. A step F23 that follows step F22 corresponds to step F9. A step F24 that follows step F23 corresponds to step F10. A step F25 that follows step F24 corresponds to step E25. A step F26 that follows step F25 corresponds to step E26.

In a step F27 which follows step F26 the computer 16 stores the fifth certificate Z5 and the seventh certificate Z7 in a third memory area of the security module 18. The security module 18 then verifies the fifth certificate Z5 using the fourth certificate Z4 and aborts the method if the result of this verification is negative. In addition, the security module 18 verifies the seventh certificate Z7 using the eighth certificate Z8 and aborts the method if the result of this verification is negative.

In an alternative step F27 the computer 16 verifies the fifth certificate Z5 using the fourth certificate Z4 and aborts the method if the result of this verification is negative. In addition, the computer 16 verifies the seventh certificate Z7 using the eighth certificate Z8 and aborts the method if the result of this verification is negative. Then, the computer 16 stores the fifth certificate Z5 and the seventh certificate Z7 in a third memory area of the communication apparatus 12 or the security module 18.

A step F28 that follows step F27 corresponds to step F12.

Now, the communication apparatus 12 is set up and can be used in the transmission methods of FIG. 5 and FIG. 6. With the following exemplary steps, the established communication apparatus 12 is checked by both the owner and the manufacturer.

In a step F29 which follows step F28 the owner checks whether the fourth certificate Z4, which is stored in the fourth memory area, is unchanged and aborts the method if the result of this check is negative.

In a step F30 which follows step F29 the manufacturer checks whether the eighth certificate Z6, which is stored in the fourth memory area, is unchanged, and aborts the method if the result of this check is negative.

A step F31 that follows step F30 corresponds to step E31. A step F32 that follows step F31 corresponds to step E32. A step F33 that follows step F32 corresponds to step E33. A step F34 that follows step F33 corresponds to step E34.

Now the communication apparatus 12 set up has been checked by both the owner and the manufacturer.

The following further exemplary embodiments should also be disclosed:

### Embodiment 1

Method for controlling an apparatus (10), wherein
a communication apparatus (12) is connected to the apparatus (10);
in a step S1, the communication apparatus (12) receives a plaintext and a signature from a sender apparatus (14);
in a step S2, the communication apparatus (12) verifies a first identifier (ID1), which is assigned to the sender apparatus (14), and a first encryption key (CS1) using a valid first certificate (Z1) and aborts the method if the result of this verification is negative;
in a step S3, the communication apparatus (12) verifies the received signature and the received plaintext using the first encryption key (CS1) and aborts the method if the result of this verification is negative;
in a step S4, the communication apparatus (12) checks whether a control instruction for the apparatus (10) is contained in the plaintext, and aborts the method if the result of this check is negative;
in a step S5, the communication apparatus (12) checks whether an authorization for the control instruction is assigned to the first encryption key (CS1) and/or the first identifier (ID1), and aborts the method if the result of this check is negative;
in a step S6, the communication apparatus (12) generates a control command for the apparatus (10) using the control instruction contained in the recovered plaintext; and
in a step S7, the communication apparatus (12) sends the control command to the apparatus (10), whereby the apparatus (10) is controlled;
the control instruction and/or the control command relates to the transmission of operating data of the apparatus (10) to a receiver apparatus (14′);
   and where after step S7:
in a step B1, the communication apparatus (12) receives the operating data from the apparatus (10);
in a step B2, the communication apparatus (12) verifies a second identifier (ID2) assigned to the receiver apparatus (14′) and a fifth encryption key (CS5) using a valid fourth certificate (Z4) and aborts the method if the result of this verification is negative;
in a step B3, the communication apparatus (12) checks whether an authorization for receiving the operating data is assigned to the fifth encryption key (CS5) and/or the second identifier (ID2), and aborts the method if the result of this check is negative; and
in a step B4, the communication apparatus (12)
   signs the operating data using a sixth decryption key (DS6) associated with the communication apparatus (12), thereby generating a signature, and
   sends the operating data and the signature to the receiver apparatus (14′).

### Embodiment 2

A method of controlling a apparatus (10), wherein
a communication apparatus (12) is connected to the apparatus (10);
in a step S1, the communication apparatus (12) receives a plaintext and a signature from a sender apparatus (14);
in a step S2, the communication apparatus (12) verifies a first identifier (ID1), which is assigned to the sender apparatus (14), and a first encryption key (CS1) using a valid first certificate (Z1) and aborts the method if the result of this verification is negative;
in a step S3, the communication apparatus (12) verifies the received signature and the received plaintext using the first encryption key (CS1) and aborts the method if the result of this verification is negative;
in a step S4, the communication apparatus (12) checks whether a control instruction for the apparatus (10) is contained in the plaintext, and aborts the method if the result of this check is negative;
in a step S5, the communication apparatus (12) checks whether an authorization for the control instruction is assigned to the first encryption key (CS1) and/or the first identifier (ID1), and aborts the method if the result of this check is negative;
in a step S6, the communication apparatus (12) generates a control command for the apparatus (10) using the control instruction contained in the recovered plaintext; and
in a step S7, the communication apparatus (12) sends the control command to the apparatus (10), whereby the apparatus (10) is controlled;
the control instruction and/or the control command relates to the sending of operating data of the apparatus (10) to a receiver apparatus (14′);
   and where after step S7:
in a step B5, the communication apparatus (12) receives the operating data from the apparatus (10);
in a step B6, the communication apparatus (12) verifies a second identifier (ID2) assigned to the receiver apparatus (14′) and a fifth encryption key (CS5) using a valid fourth certificate (Z4) and aborts the method if the result of this verification is negative;
in a step B7, the communication apparatus (12) checks whether an authorization for receiving the operating data is assigned to the fifth encryption key (CS5) and/or the second identifier (ID2), and aborts the method if the result of this check is negative; and
in a step B8, the communication apparatus (12)
   encrypts the operating data using the fifth encryption key (CS5),
   signs the operating data or the encrypted operating data using a sixth decryption key (DS6) associated with the communication apparatus (12), thereby generating a signature, and
   sends the encrypted operating data and the signature to the receiver apparatus (14′).

### Embodiment 3

A method of controlling a apparatus (10), wherein
a communication apparatus (12) is connected to the apparatus (10);
in a step S8, the communication apparatus (12) receives a ciphertext and a signature from a sender apparatus (14), wherein the ciphertext represents an encrypted plaintext;
in a step S9, the communication apparatus (12) verifies a first identifier (ID1) assigned to the sender apparatus (14) and a first encryption key (CS1) using a valid first certificate (Z1) and aborts the method if the result of this verification is negative;
in a step S10, the communication apparatus (12) decrypts the received ciphertext using a second decryption key (DS2) associated with the communication apparatus (12), thereby restoring the plaintext;
in a step S11, the communication apparatus (12) verifies the received signature and the received ciphertext or the received signature and the recovered plaintext using the first encryption key (CS1) and aborts the method if the result of this verification is negative;
in a step S12, the communication apparatus (12) checks whether a control instruction for the apparatus (10) is contained in the plaintext, and aborts the method if the result of this check is negative;
in a step S13, the communication apparatus (12) checks whether an authorization for the control instruction is assigned to the first encryption key (CS1) and/or the first identifier (ID1), and aborts the method if the result of this check is negative;
in a step S14, the communication apparatus (12) generates a control command for the apparatus (10) using the control instruction contained in the recovered plaintext; and
in a step S15, the communication apparatus (12) sends the control command to the apparatus (10), whereby the apparatus (10) is controlled;
the control instruction and/or the control command relates to the sending of operating data of the apparatus (10) to a receiver apparatus (14′);
   and where after step S15:
in a step B1, the communication apparatus (12) receives the operating data from the apparatus (10);
in a step B2, the communication apparatus (12) verifies a second identifier (ID2) assigned to the receiver apparatus (14′) and a fifth encryption key (CS5) using a valid fourth certificate (Z4) and aborts the method if the result of this verification is negative;
in a step B3, the communication apparatus (12) checks whether an authorization for receiving the operating data is assigned to the fifth encryption key (CS5) and/or the second identifier (ID2), and aborts the method if the result of this check is negative; and
in a step B4, the communication apparatus (12)
   signs the operating data using a sixth decryption key (DS6) associated with the communication apparatus (12), whereby a signature is generated, and
   sends the operating data and the signature to the receiver apparatus (14′).

### Embodiment 4

A method of controlling a apparatus (10), wherein
a communication apparatus (12) is connected to the apparatus (10);
in a step S8, the communication apparatus (12) receives a ciphertext and a signature from a sender apparatus (14), wherein the ciphertext represents an encrypted plaintext;
in a step S9, the communication apparatus (12) verifies a first identifier (ID1) assigned to the sender apparatus (14) and a first encryption key (CS1) using a valid first certificate (Z1) and aborts the method if the result of this verification is negative;
in a step S10, the communication apparatus (12) decrypts the received ciphertext using a second decryption key (DS2) associated with the communication apparatus (12), whereby the plaintext is recovered;
in a step S11, the communication apparatus (12) verifies the received signature and the received ciphertext or the received signature and the recovered plaintext using the first encryption key (CS1) and aborts the method if the result of this verification is negative;
in a step S12, the communication apparatus (12) checks whether a control instruction for the apparatus (10) is contained in the plaintext, and aborts the method if the result of this check is negative;
in a step S13, the communication apparatus (12) checks whether an authorization for the control instruction is assigned to the first encryption key (CS1) and/or the first identifier (ID1), and aborts the method if the result of this check is negative;
in a step S14, the communication apparatus (12) generates a control command for the apparatus (10) using the control instruction contained in the recovered plaintext; and
in a step S15, the communication apparatus (12) sends the control command to the apparatus (10), whereby the apparatus (10) is controlled;
the control instruction and/or the control command relates to the transmission of operating data of the apparatus (10) to a receiver apparatus (14′);
   and where after step S15:
in a step B5, the communication apparatus (12) receives the operating data from the apparatus (10);
in a step B6, the communication apparatus (12) verifies a second identifier (ID2) assigned to the receiver apparatus (14′) and a fifth encryption key (CS5) using a valid fourth certificate (Z4) and aborts the method if the result of this verification is negative;
in a step B7, the communication apparatus (12) checks whether an authorization for receiving the operating data is assigned to the fifth encryption key (CS5) and/or the second identifier (ID2), and aborts the method if the result of this check is negative; and
in a step B8, the communication apparatus (12)
   the operating data is encrypted using the fifth encryption key (CS5),
   signs the operating data or the encrypted operating data using a sixth decryption key (DS6) associated with the communication apparatus (12), thereby generating a signature, and
   sends the encrypted operating data and the signature to the receiver apparatus (14′).

### Embodiment 5

Method according to one of embodiments 1, 2, 3 or 4, wherein
the first encryption key (CS1) is or is being stored in the communication apparatus (12); and/or
the first encryption key (CS1) is contained in the plaintext and/or in a signature file containing the signature, and the communication apparatus (12) extracts the first encryption key (CS1) from the plaintext and/or from the signature file;
and/or
the communication apparatus (12) has received or receives the first encryption key (CS1), in particular by downloading it from a key server.

### Embodiment 6

Method according to one or more of embodiments 1 to 5, wherein the checking according to step S5 or S13 is performed by the communication apparatus (12) checking whether the authorization is contained in the first encryption key (CS1) and/or is assigned to the first encryption key (CS1) and/or the first identifier (ID1) in a configuration file.

### Embodiment 7

Method according to embodiment 6, wherein in a step S16 the communication apparatus (12) checks whether the configuration file has been signed using a valid second certificate (Z2) and aborts the method if the result of this check is negative;

### Embodiment 8

A method according to one or more of embodiments 1 to 7, wherein
the sending according to step S7 or S15 comprises that the communication apparatus (12)
   encrypts the control command using a third cipher key (CS3) associated with the apparatus (10), and
   sends the encrypted control command to the apparatus (10);
or the sending according to step S7 or S15 comprises that the communication apparatus (12)
   signs the control command using the second decryption key (DS2) or a fourth decryption key (DS4) associated with the communication apparatus (12), whereby a signature is generated, and
   sends the control command and the signature to the apparatus (10);
or the sending according to step S7 or S15 comprises that the communication apparatus (12)
   encrypts the control command using a third encryption key (CS3) assigned to the apparatus (10),
   signs the control command or the encrypted control command using the second decryption key (DS2) or a fourth decryption key (DS4) associated with the communication apparatus (12), whereby a signature is generated, and
   sends the encrypted control command and the signature to the apparatus (10).

### Embodiment 9

Method according to embodiment 8, wherein
the communication apparatus (12) comprises a computer (16) in which the first encryption key (CS1), the third encryption key (CS3), the first identifier (ID1) and/or the configuration file is stored; and/or
the communication apparatus (12) comprises a security module (18) in which the first certificate (Z1), the second certificate (Z2), the second decryption key (DS2) and/or the fourth decryption key (DS4) is stored.

### Embodiment 10

A method according to one or more of embodiments 1 to 9, wherein
the communication apparatus (12) comprises
   a computer (16), and
   a security module (18) connected to the computer (16);
data is transferred from the computer (16) to the security module (18) and from the security module (18) to the computer (16); and
this transmission of data is protected by a protection realized by software and/or hardware which prevents the transmitted data from being read and/or modified and/or ensures that only the computer (16) can control this transmission of data and/or that this transmission of data can only take place with the aid of a password which is stored exclusively in the computer (16).

### Embodiment 11

A method according to one or more of embodiments 9 to 10, wherein
the security module (18) has a write protection realized by software and/or hardware, which prevents the first certificate (Z1) stored in the security module (18), the second certificate (Z2) stored in the security module (18), the second decryption key (DS2) stored in the security module (18) and/or the fourth decryption key (DS4) stored in the security module (18) from being changed; and/or
the security module (18) has a read protection realized by software and/or hardware, which prevents the second decryption key (DS2) stored in the security module (18) and/or the fourth decryption key (DS4) stored in the security module (18) from being read.

### Embodiment 12

Method according to one or more of embodiments 1 to 11, wherein prior to step S1 or S8, in a step S19, an encrypted data connection is established between the sender apparatus (14) and the communication apparatus (12) according to an encryption protocol.

### Embodiment 13

A method according to embodiment 2 and one or more of embodiments 5 to 12 or according to embodiment 4 and one or more of embodiments 5 to 12, wherein
in a step B9, the communication apparatus (12) decrypts the received encrypted operation data using the sixth decryption key (DS6) or a seventh decryption key (DS7) corresponding to the seventh encryption key (CS7), thereby restoring the operation data;
in a step B10, the communication apparatus (12) verifies the received operation data and the received signature using an eighth encryption key (CS8) corresponding to the eighth decryption key (DS8) and aborts the method if the result of this verification is negative; and
in a step B11, the communication apparatus (12)
   decrypts the received encrypted operating data using the sixth decryption key (DS6) or a seventh decryption key (DS7) corresponding to the seventh encryption key (CS7), whereby the operating data is recovered, and
   verifies the received encrypted operating data and the received signature or the recovered operating data and the received signature using an eighth encryption key (CS8) corresponding to the eighth decryption key (DS8) and aborts the method if the result of this verification is negative.

### Embodiment 14

The method according to one or more of embodiments 1 to 13, wherein prior to transmitting according to step B4 or B8, an encrypted data connection is established between the communication apparatus (12) and the receiver apparatus (14′) according to an encryption protocol in a step B12.

### Embodiment 15

A communication apparatus (12) comprising
means for performing a method according to embodiment 1 and one or more of embodiments 5 to 14;
means for performing a method according to embodiment 2 and one or more of embodiments 5 to 14;
means for performing a method according to embodiment 3 and one or more of embodiments 5 to 14; and/or
means for performing a method according to embodiment 4 and one or more of embodiments 5 to 14.

### Embodiment 16

A computer program, comprising instructions which, when executed by a computer (16) or a communication apparatus (12) according to embodiment 15, cause the computer (16) or the communication apparatus (12) to perform a method according to embodiment 1 and one or more of embodiments 5 to 14, a method according to embodiment 2 and one or more of embodiments 5 to 14, a method according to embodiment 3 and one or more of embodiments 5 to 14, and/or a method according to embodiment 4 and one or more of embodiments 5 to 14.

### Embodiment 17

Computer-readable medium,
on which the computer program according to embodiment 16 is stored; and/or comprising instructions which, when executed by a computer (16) or a communication apparatus (12) according to embodiment 15, cause the computer (16) or the communication apparatus (12) to perform a method according to embodiment 1 and one or more of embodiments 5 to 14, a method according to embodiment 2 and one or more of embodiments 5 to 14, a method according to embodiment 3 and one or more of embodiments 5 to 14, and/or a method according to embodiment 4 and one or more of embodiments 5 to 14.

### Embodiment 18

Data carrier signal that transmits the computer program according to embodiment 16.

In addition, any of the methods, processes and actions described or illustrated herein may be implemented using executable instructions (for example, a computer program) in a general purpose or specialized processor and stored on a computer-readable storage medium (e.g., hard disk, memory or the like) for execution by such a processor. References to a “computer-readable storage medium” are to be understood to include specialized circuitry such as FPGAs, ASICs, signal processing devices, and other devices.

The term “A and/or B” includes one of the following three scenarios: (i) A, (ii) B, (iii) A and B. The expression “A and/or B” has the same meaning as “at least one of A or B” and “at least one of A and B”. Furthermore, the article “one” is not to be understood as “one”, i.e. the use of the expression “one element” does not exclude the presence of further elements. The term “comprising” is to be understood in an open sense, i.e. that an article “comprising an element A” may also comprise further elements in addition to element A.

### LIST OF REFERENCE SYMBOLS

10 apparatus
12 communication apparatus
14/14′ sender apparatus/receiver apparatus
16 computer of 12
18 security module of 12
20 communication interface of 10
22′/22″ first/second communication interface of 12
24 communication interface of 14
26 Machine of 10
CS1/DS1 first encryption key/decryption key of 14
CS2/DS2 second encryption key/decryption key of 12
CS3/DS3 third encryption key/decryption key of the owner of 10
CS4/DS4 fourth encryption key/decryption key of 12
CS5/DS5 fifth encryption key/decryption key of 14′
CS6/DS6 sixth encryption key/decryption key of 12
CS7/DS7 seventh encryption key/decryption key of 12
CS8/DS8 eighth encryption key/decryption key of 10
CS9/DS9 nineth encryption key/decryption key of the manufacturer of 10
ID1 first identifier of 14
ID2 second identifier of 14′
ID3 third identifier of 10
Z1 first certificate for CS1 (issued by the owner of 10)
Z2 second certificate for the configuration file (issued by the owner and/or manufacturer of 10)
Z3 third certificate for the firmware (issued by the owner and/or manufacturer of 10 and/or manufacturer of 12)
Z4 fourth certificate for CS5 (issued by the owner of 10)
Z5 fifth certificate for CS2 (issued by the owner of 10)
Z6 sixth certificate for CS1 (issued by the manufacturer of 10)
Z7 seventh certificate for CS2 (issued by the manufacturer of 10)
Z8 eighth certificate for CS5 (issued by the manufacturer of 10)

1-20. (canceled)

21. A computer-readable medium encoded with computer instructions that, when executed by a communication apparatus, establish computer processes for controlling an apparatus coupled to the communication apparatus, the computer processes comprising:
in a step S1, receiving a plaintext and a signature from a sender apparatus;
in a step S2, verifying a first identifier which is associated with the sender apparatus and a first encryption key using a valid first certificate, wherein the verifying is performed by checking, using the first certificate, whether the first encryption key matches with the first identifier, and aborting the method if the result of this verification is negative, wherein the first certificate is stored in a security module comprised by the communication apparatus;
in a step S3, verifying the received signature and the received plaintext using the first encryption key and aborting the method if the result of this verification is negative;
in a step S4, checking whether a control instruction for the apparatus is contained in the plaintext and aborting the method if the result of this check is negative;
in a step S5, checking whether an authorization for the control instruction is associated with the first encryption key and the first identifier, and aborting the method if the result of this check is negative;
in a step S6, generating a control command for the apparatus using the control instruction contained in the recovered plaintext; and
in a step S7, sending the control command to the apparatus, whereby the apparatus is controlled.

22. The computer-readable medium according to claim 21, wherein the computer processes further comprise:
storing the first encryption key in the communication apparatus; and/or
extracting the first encryption key from the plaintext and/or from the signature file; and/or
downloading the first encryption key from a key server.

23. The computer-readable medium according to claim 21, wherein the checking according to step S5 is done by the communication apparatus checking whether the authorization is contained in the first encryption key and/or is associated with the first encryption key and/or the first identifier in a configuration file.

24. The computer-readable medium according to claim 21, wherein the computer processes further comprise, in a step S16, checking by the communication apparatus, whether the configuration file has been signed using a valid second certificate, and aborting the method if the result of this check is negative;

25. The computer-readable medium according to claim 21, wherein
the sending according to step S7 comprises that the communication apparatus encrypts the control command using a third encryption key associated with the apparatus, and
sends the encrypted control command to the apparatus;
or the sending according to step S7 comprises that the communication apparatus signs the control command using the second decryption key or a fourth decryption key which is associated with the communication apparatus, whereby a signature is generated, and
sends the control command and the signature to the apparatus;
or the sending according to step S7 comprises that the communication apparatus encrypts the control command using a third encryption key associated with the apparatus,
signs the control command or the encrypted control command using the second decryption key or a fourth decryption key associated with the communication apparatus, whereby a signature is generated, and
sends the encrypted control command and the signature to the apparatus.

26. The computer-readable medium according to claim 21, wherein the computer processes further comprise
storing in the communication apparatus the first encryption key, the third encryption key, the first identifier and/or the configuration file; and/or
storing in the security module the second certificate, the second decryption key and/or the fourth decryption key.

27. The computer-readable medium according to claim 21, wherein the communication apparatus comprises a computer and the security module and the computer processes further comprise a protection method
which prevents the data transferred between the computer and the security module from being read along and/or modified and/or ensures that only the computer can control this transfer of data and/or that this transfer of data can only take place with the aid of a password which is stored exclusively in the computer.

28. The computer-readable medium according to claim 21, wherein the computer processes further comprise
a write protection method for the security module, which write protection prevents alteration of the first certificate stored in the security module, of the second certificate stored in the security module, of the second decryption key stored in the security module and/or of the fourth decryption key stored in the security module; and/or
a read protection method for the security module, which prevents reading of the second decryption key stored in the security module and/or of the fourth decryption key stored in the security module.

29. The computer-readable medium according to claim 21, wherein the computer processes further comprise, in a step S19 executed prior to step S1, establishing an encrypted data connection between the sender apparatus and the communication apparatus according to an encryption protocol.

30. The computer-readable medium according to claim 21, wherein the control instruction and/or control command relates to sending operating data of the apparatus to the sender apparatus or to a receiver apparatus.

31. A computer-readable medium encoded with computer instructions that, when executed by a communication apparatus, establish computer processes for controlling an apparatus coupled to the communication apparatus, the computer processes comprising:
in a step S8, receiving a ciphertext and a signature from a sender apparatus, wherein the ciphertext represents an encrypted plaintext;
in a step S9, verifying a first identifier associated with the sender apparatus and a first encryption key using a valid first certificate, wherein the verifying is performed by checking, using the first certificate, whether the first encryption key matches with the first identifier, and aborting the method if the result of this verification is negative, wherein the first certificate is stored in a security module comprised by the communication apparatus;
in a step S10, decrypting the received ciphertext using a second decryption key associated with the communication apparatus, whereby the plaintext is recovered;
in a step S11, verifying the received signature and the received ciphertext or the received signature and the restored plaintext using the first encryption key and aborting the method if the result of this verification is negative;
in a step S12, checking whether a control instruction for the apparatus is contained in the plaintext and aborting the method if the result of this check is negative;
in a step S13, checking whether an authorization for the control instruction is associated with the first encryption key and the first identifier, and aborting the method if the result of this check is negative;
in a step S14, generating a control command for the apparatus using the control instruction contained in the restored plaintext; and
in a step S15, sending the control command to the apparatus, whereby the apparatus is controlled.

32. The computer-readable medium according to claim 31, wherein the computer processes further comprise:
storing the first encryption key in the communication apparatus; and/or
extracting the first encryption key from the plaintext and/or from the signature file; and/or
downloading the first encryption key from a key server.

33. The computer-readable medium according to claim 31, wherein the checking according to step S13 is done by the communication apparatus checking whether the authorization is contained in the first encryption key and/or is associated with the first encryption key and/or the first identifier in a configuration file.

34. The computer-readable medium according to claim 31, wherein the computer processes further comprise, in a step S16, checking by the communication apparatus, whether the configuration file has been signed using a valid second certificate, and aborting the method if the result of this check is negative;

35. The computer-readable medium according to claim 31, wherein
the sending according to step S15 comprises that the communication apparatus encrypts the control command using a third encryption key associated with the apparatus, and
sends the encrypted control command to the apparatus;
or the sending according to step S15 comprises that the communication apparatus signs the control command using the second decryption key or a fourth decryption key which is associated with the communication apparatus, whereby a signature is generated, and
sends the control command and the signature to the apparatus;
or the sending according to step S15 comprises that the communication apparatus encrypts the control command using a third encryption key associated with the apparatus,
signs the control command or the encrypted control command using the second decryption key or a fourth decryption key associated with the communication apparatus, whereby a signature is generated, and
sends the encrypted control command and the signature to the apparatus.

36. The computer-readable medium according to claim 31, wherein the computer processes further comprise
storing in the communication apparatus the first encryption key, the third encryption key, the first identifier and/or the configuration file; and/or
storing in the security module the second certificate, the second decryption key and/or the fourth decryption key.

37. The computer-readable medium according to claim 31, wherein the communication apparatus comprises a computer and the security module and the computer processes further comprise a protection method
which prevents the data transferred between the computer and the security module from being read along and/or modified and/or ensures that only the computer can control this transfer of data and/or that this transfer of data can only take place with the aid of a password which is stored exclusively in the computer.

38. The computer-readable medium according to claim 31, wherein the computer processes further comprise
a write protection method for the security module, which write protection prevents alteration of the first certificate stored in the security module, of the second certificate stored in the security module, of the second decryption key stored in the security module and/or of the fourth decryption key stored in the security module; and/or
a read protection method for the security module, which prevents reading of the second decryption key stored in the security module and/or of the fourth decryption key stored in the security module.

39. The computer-readable medium according to claim 31, wherein the computer processes further comprise, in a step S19 executed prior to step S8, establishing an encrypted data connection between the sender apparatus and the communication apparatus according to an encryption protocol.

40. The computer-readable medium according to claim 31, wherein the control instruction and/or control command relates to sending operating data of the apparatus to the sender apparatus or to a receiver apparatus.

41. A computer-readable medium encoded with computer instructions that, when executed by a communication apparatus, establish computer processes for sending operating data of an apparatus to a receiver apparatus, the computer processes comprising:
in a step B1, receiving operating data from the apparatus;
in a step B2, verifying a second identifier which is associated with the receiver apparatus and a fifth encryption key using a valid fourth certificate, wherein the verifying is performed by checking, using the fourth certificate, whether the fifth encryption key matches with the second identifier, and aborting the method if the result of this verification is negative, wherein the fourth certificate is stored in a security module comprised by the communication apparatus;
in a step B3, checking whether an authorization for receiving the operating data is assigned to the fifth encryption key and to the second identifier, and aborting the method if the result of this check is negative; and
in a step B4,
signing the operating data using a sixth decryption key associated with the communication apparatus, whereby a signature is generated, and
sending the operating data and the signature to the receiver apparatus.

42. The computer-readable medium according to claim 41, wherein the computer processes further comprise:
in a step B9, decrypting the received encrypted operating data using the sixth decryption key or a seventh decryption key that corresponds to the seventh encryption key, whereby the operating data are recovered;
in a step B10, verifying the received operating data and the received signature using an eighth encryption key that corresponds to the eighth decryption key, and aborting the method if the result of this verification is negative; and
in a step B11,
decrypting the received encrypted operating data using the sixth decryption key or a seventh decryption key that corresponds to the seventh encryption key, whereby the operating data is recovered, and
verifying the received encrypted operating data and the received signature or the recovered operating data and the received signature using an eighth cipher key, which corresponds to the eighth decryption key, and aborting the method if the result of this verification is negative.

43. The computer-readable medium according to claim 41, wherein the computer processes further comprise in a step B12 executed prior to the sending according to step B4, establishing an encrypted data connection between the communication apparatus and the receiver apparatus according to an encryption protocol.

44. A computer-readable medium encoded with computer instructions that, when executed by a communication apparatus, establish computer processes for sending operating data of an apparatus to a receiver apparatus, the computer processes comprising;
in a step B5, receiving operating data from the apparatus;
in a step B6, verifying a second identifier which is associated with the receiver apparatus and a fifth encryption key using a valid fourth certificate, wherein the verifying is performed by checking, using the fourth certificate, whether the fifth encryption key matches with the second identifier, and aborting the method if the result of this verification is negative, wherein the fourth certificate is stored in a security module comprised by the communication apparatus;
in a step B7, checking whether an authorization for receiving the operating data is assigned to the fifth encryption key and to the second identifier, and aborting the method if the result of this check is negative; and
in a step B8,
encrypting the operating data using the fifth encryption key,
signing the operating data or the encrypted operating data using a sixth decryption key which is associated with the communication apparatus, whereby a signature is generated, and
sending the encrypted operating data and the signature to the receiver apparatus.

45. The computer-readable medium according to claim 44, wherein the computer processes further comprise:
in a step B9, decrypting the received encrypted operating data using the sixth decryption key or a seventh decryption key that corresponds to the seventh encryption key, whereby the operating data are recovered;
in a step B10, verifying the received operating data and the received signature using an eighth encryption key that corresponds to the eighth decryption key, and aborting the method if the result of this verification is negative; and
in a step B11,
decrypting the received encrypted operating data using the sixth decryption key or a seventh decryption key that corresponds to the seventh encryption key, whereby the operating data is recovered, and
verifying the received encrypted operating data and the received signature or the recovered operating data and the received signature using an eighth cipher key, which corresponds to the eighth decryption key, and aborting the method if the result of this verification is negative.

46. The computer-readable medium according to claim 44, wherein the computer processes further comprise in a step B12 executed prior to the sending according to step B8, establishing an encrypted data connection between the communication apparatus and the receiver apparatus according to an encryption protocol.

47. A communication apparatus comprising at least one processor and at least one computer-readable medium according to claim 21.

48. A communication apparatus comprising at least one processor and at least one computer-readable medium according to claim 31.

49. A communication apparatus comprising at least one processor and at least one computer-readable medium according to claim 41.

50. A communication apparatus comprising at least one processor and at least one computer-readable medium according to claim 44.
